(19) United States
(12) Patent Application Publication
(10) Pub. No.: US 2020/0080664 A1
(43) Pub. Date: Mar. 12, 2020

(54) CONDUIT AND COMPONENT SUPPORT SYSTEM

(71) Applicant: Shawn Frederick Douglas Perry, Winnipeg (CA)

(72) Inventor: Shawn Frederick Douglas Perry, Winnipeg (CA)

(21) Appl. No.: 16/127,188

(22) Filed: Sep. 10, 2018

(51) Int. Cl. F16L 3/24; F16L 3/133; F16L 3/18; H02G 3/32

(52) U.S. Cl. CPC F16L 3/24; H02G 3/32; F16L 3/18; F16L 3/133

(57) ABSTRACT

A conduit and component support system for support of flexible, semi flexible or ridged conduit, pipe, wire, or similar, herein referred to as conduit which is comprised of one or more attachment points completing the underlying supporting framework for conduits. This system may be comprised of a nonmetallic elastomeric material or similar where a conduit can either be placed on the support or inserted into an insert opening within the support. This system provides support for conduit elongated runs and also to where the joining of conduits is made, where changes in direction are made, or where attachment points are made within a conduit system. Examples: 90 degree turns, tee fittings, couplings, valves, junction boxes, or similar to those previously mentioned. The system may also provide; physical protection, allowance for expansion and contraction, corrosion protection, dielectric protection, wear protection, identification, vibration and shock protection for conduits, the system, or structures.

### CROSS-REFERENCE TO RELATED APPLICATIONS

This application claims priority to provisional U.S. Application No. 62/559,549 filed Sep. 16, 2017; U.S. Application No. 62/590,541 filed Oct. 25, 2017; and U.S. Application No. 62/655,813 filed Apr. 11, 2018.

### FIELD OF INVENTION

The invention is a conduit support system for use in supporting or securing piping, conduits and electrical wiring found in plumbing waste, water and venting, heating and air conditioning, gas lines in liquid and vapor states, oil piping, pneumatic and hydraulic piping, fire protection systems, electrical conduits and wires or similar to any of the previous mentioned all herein referred to as conduits. The support system in some aspects will include the support of the fittings and components used within a conduit; such fittings and components included but are not limited to 90 degree elbows, 45 degree elbows, T fittings, couplings, flanges, unions, valves, regulators, junction boxes, disconnects, meters, or any other fitting and component that might be required for use as part of a conduit system to complete the installation. The above described fittings and components herein may be refereed to as component.

### BACKGROUND OF THE INVENTION

The background for the invention or device as described is based on mechanical executions including risk assessed engineering for supporting and securing conduits within or on one embodiment and for attaching or placing those conduits within or on the said embodiment to other structures or objects. Structures which may include attachment and or placement on a roof, to a roof pipe support, a trusses, beams, u-channel, u-channel strut, angle iron, machinery or similar to those listed above where compensation is given for conduit expansion and contraction, corrosion protection, physical protection, wear, identification, vibrations, temperature transfer, shock, ease of installation, and cost savings. The device or invention can be used in mechanical fields including plumbing, heating, air conditioning, electrical, fire protection and related trade disciplines. The use of the word invention or device may be interchangeable throughout this writing or disclosure and the meaning is understood to describe the invention or device in the same manner.

Previous prior art show means or provide teaching for pipe supporting, hanging or similar and each add value to mechanical trades from Lombard U.S. Pat. No. 2,166,916 to SixSmith U.S. Pat. No. 9,903,512 prior art has provided individual solutions for support of a conduit, piping or similar. While each individual solution described and illustrated in prior arts solves problems or adds value, the present invention provides a system which creates a multi functional support and hanger for conduits. This now disclosed invention does not only recognize one or two challenges faced by designers, engineers and installers but focuses on the integration of expansion and contraction, corrosion protection, dielectric isolation, wear, physical protection, identification of the conduit including contents inside the conduit, vibrations with respect given to such forces as hydraulic shock and seismic movement, parallel positioning distance protection, ease of installation, critical support to the components such as couplings, 90 degree elbows, T fittings, valves, regulators, unions, junction box's other related or associated mechanical components herein referred to as component, or any such place that protection or support needs to be provided from load bearing forces external to or from the conduits themselves in one device or system of support.

This invention, in one device or embodiment solves the above expansion and contraction including corrosion protection within the conduit. Engineering tolerances provided within the design wherein the conduits size is compensated for in relation to the conduit support area. Expansion and contraction due to temperature change is a factor considered through risk assessment in the engineering and design of this invention. Temperature changes are not only created externally from ambient temperatures but also internal to the conduits themselves and therefore in many cases are not controllable, but manageable. This invention manages thermal expansion and contraction by allowing this natural effect to occur controlling it throughout the entire system. When conduits are suppressed from hanger to hanger or clip to clip by tightly fastening them not only do the conduits warp and bend between these hangers but sometimes hangers can be dislodged by thermal expansion forces or more severely conduits themselves can be damaged. While previous prior arts rely on moving parts or material selection for expansion and contraction, this invention prevents damages caused by thermal expansion and contraction by managing the effects with engineering tolerances designed within the invention where no actions are needed by the installer to accommodate for thermal expansion or contraction.

Another advantage with certain aspects of this invention or device as described is the singular use of the hanger or support in one embodiment to where attachment is possible to different objects including attachment to open channel strut without additional retaining components. The device or invention as described and illustrated in the drawings continues with advantages where no pressure or force is imposed on the conduit itself for attachment. Many similar u-channel strut clamps or supports tighten conduits against open channel strut to secure a conduit. This invention or device can be friction fit where no pressure or force is applied by or applied to a conduit.

Still another advantage of the invention is the physical protection engineering as part of the device. Many conduits are either installed outside a building structure where they travel to concrete pads or other structures beside or outside of the main building structure, on roof tops, beside or at machinery, inside or outside areas where workers must travel to complete inspections, work on or above conduits leaving conduits unprotected from physical damages. Prior art Jentzsch U.S. Pat. No. 3,888,186; Valeri U.S. Pat. No. 4,067,258 Martin U.S. Pat. No. 5,095,822; Herman U.S. Pat. No. 5,777,266; Berardi U.S. Pat. No. 6,499,410; Henry U.S. Pat. No. 6,878,811; Lubanski U.S. Pat. No. 7,309,836; Henry U.S. Pat. No. 7,939,759; Lubanski U.S. Pat. No. 8,119,914 and Lioi U.S. Pat. No. 9,438,022; describe and teach of protection methods in the forms of ramps for heavy equipment or foot traffic at special events. This invention as disclosed is not meant for protection of vehicular traffic but from physical damages to the conduits caused by workers standing on conduits to gain access to other equipment, falling objects from workers working above conduits, from processes of equipment or those from such physical damages that can occur from moving or falling ice and snow loads. The design of this invention has built in tolerances for outside forces such as impact from falling objects, foot traffic and similar forces imposed on conduits while providing inspection access without dismantling the protection device also providing identification to conduits. Furthermore, this invention will allow for simple attachment where conduits are installed within or around pipe racking. Many conduits require work to be completed within such pipe racking where workers have to build on site wooded structures or similar. The invention as described and illustrated in the drawing figures now solves physical protection of a conduit relative to size wherein now protection can be accomplished within or around equipment, in pipe racking, on roof areas, between buildings or similar to those areas above.

Protection of a conduit is critical in the success of the functions in which a conduit performs and as such this invention through risk assessment provides not only protection as described above but allowance and compensation for conduit release from structural objects. Extreme movement or fatigue of a structural object to where a conduit is attached can cause extreme harm to a conduit support, a conduit and to the function a conduit performs; now as disclosed this invention can manage extreme conditions by allowing a conduit to be released prior to critical fatigue of the conduit.

Another advantage of the current invention is the support of semi rigid conduits where support is not only provided at strategically placed supports, but throughout the entire run of a conduit. Past practices have been the use of wooden planks placed beneath corrugated conduits for entire system support, this invention now solves entire system protection for semi rigid conduits as well.

Vibrations within conduit systems including those apparent in liquid system are accounted for and protected from within this said invention or device. Hydraulic shock is due to flow being suddenly stopped within a conduit and should be accounted for within the designs of conduit protection. Devices like shock absorbers and expansion tanks provide internal relief for hydraulic shock as shown by Tsai U.S. Pat. No. 9,004,110, however, this does not protect the outside of the conduit if such devices intended to absorb inner shock are not installed, or depleted, undersized or not installed in the correct location. These vibrations due to hydraulic shock can cause conduits to bang, move or break. The effects caused by hydraulic shock if not suppressed or managed within a conduit can be lessened by this invention. This device itself provides external absorption of hydraulic shock not only dampening the sound of this condition but reducing effects such as wear of the conduit and conduit retainer. Internal protection is always recommended and cannot in itself be solved by supports or hangers, however, this invention can aid the internal measures required. Mastro U.S. Pat. No. 5,261,633 does make mention of providing a solution for the sound of “water hammer” by separating a conduit from a metal hanger, however this method of separation does not correct or aid in the condition of hydraulic shock. The invention as now described not only solves the sound of hydraulic shock, but more importantly allows the opposite action of hydraulic shock to happen naturally inside the conduit allowing the conduit and this invention to absorb the impact caused by hydraulic shock also providing protection impact from external physical forces and those that may occur due to settling of structures and vibrations which also includes vibrations which might occur due to seismic activity.

Still another advantage of the present invention is centerline measuring provided within the device where known measurements are provided from the center of the conduit support area to the outside of the device. This known measurement allows installers precise measuring. This is not only important for straight parallel conduit guiding for appearances but for those installations that require precise clearances from other conduits such as a gas conduit distance from an electrical conduit.

Visual identification is another advantage within this invention, not only for physical contact incidents but also as a visual working aid. This can be accomplished by coloring the invention differently and or labeling the invention. Color coding or identification of the device will give immediate notification to workers, engineers, fire fighters, safety personnel or similar what the conduit contains, if the conduit is hot or cold, the electrical current, voltage and phase, where a conduit is fed from or where a conduit begins or ends. This identification by color, numbering, lettering or labelling solves cost and hazards associated with the above. Prior art Ibey U.S. Pat. No. 6,772,634 teaches and solves the problem of identification of conduit ends by the use of a sonic transmitter and a sonic receiver; while this invention or prior art taught by Ibey is needed and solves a great problem for the electrical industry, the marking system which is accomplished within this device allows for identification prior to or after the invention of Ibey is used wherein the conduits should be identified. Moreover, many conduits are typically supported in the same areas, this identification can now from a glance identify the conduit. Such examples could be a blue colored device for compressed air lines, yellow color for flammable gasses in a vapor state, red for fire-quenching fluids or wording such as 600 volt. Current conduit hangers or supports in the basics of the design may not allow for such marking or labelling on the conduit hanger or support and rely on conduit marking in the form of banding on the conduit such as prior art Piana U.S. Pat. No. 4,268,986; Clement U.S. Pat. No. 4,844,000; Niwa U.S. Pat. No. 5,138,784; or methods of marking such as Bennett U.S. Pat. No. 9,446,877 or by painting the conduit a desired color. As described and shown conduit marking and identification is important and now with this invention expensive painting or marking of the conduit could be minimized as marking and identification is provided within this device or invention.

Another advantage over other prior art is the development of the “Insert Single Block” “Insert Double Block”, “Double Block”, “Insert 90 Block”, “90 Block”, “Insert T Block”, and “T Block” that integrate a means of securing, supporting and guiding conduits and wire systems regardless of size or numbers with emphasis on code compliance, public health and safety, mechanical impact protection and points of joining within a conduit system. The described devices may provide in some models support not only to the conduits but also where critical support to the components such as couplings, 90 degree elbows, T fittings, valves, regulators, unions, junction box's or other related to those described or other associated mechanical components herein referred to as component, or any such places that protection or support needs to be provided from load bearing forces external to or from the conduits themselves. This is of particular importance in systems where threaded or grooved ends of conduits have removed base metals in the process of such actions or in systems where attachments are glued or attached with screws or connectors. Such systems which are, but not limited to electrical, gas, plumbing, refrigeration and air conditioning. By supporting all conduit ends where components are attached the invention creates a total system of support to any conduit system. Prior art Rook U.S. Pat. No. 9,528,271, Brown U.S. Pat. No. 9,523,380, Krovates U.S. Pat. No. 8,312,692 Hillman D692,393 and Tally D738,711 and others provide support as a singular block that can only support one area at a time and means of support is only for a pipe and not the complete system in which only a single support is used and placed at locations randomly or not placed in critical areas such as joints or changes of direction leaving one or more attachment points unprotected, unsupported or incorrectly installed or easily moved accidentally during renovations, repairs or other such actions after the conduits have been installed, supported and inspected. This invention or support system complete with the “Insert Double Block”, “Double Block”, “Insert 90 Block”, “90 Block”, “Insert T Block” and “T Block” are singular supports in design but encompass all sides of a component providing support at both or all sides of associated components held within a conduit system, in turn not only providing full support of the conduit system but also the associated components within a single block or support. National codes make reference to supporting ends of threaded piping and providing correctly mounted, braced and supported conduits. This invention solves support of conduits as per Codes while enabling those installing conduits and supports to do so more efficiently and safely with proper planning and engineering provided within this invention.

This invention as disclosed solves through risk assessed engineering not only one or two challenges for mechanical trades but provides advantages and solves conditions or effects of thermal expansion and contraction, corrosion protection, dielectric protection, physical protection, component inspection, wear, identification, vibrations and shock and ease of installation. Providing support to all aspects of conduit systems as a whole by providing weakest link protection in component support by the invention of “Insert Double Block”, “Double Block”, “Insert 90 Block”, “90 Block”, “Insert T Block” and “T Block” while incorporating inspection and testing areas this invention is not only a conduit support but a managed system of support; an invention focused on conforming to Codes, Standards and good engineering practices by eliminating the hazard.

### SUMMARY

The now disclosed invention and support system as described is a general summary of the invention, and is not a comprehensive disclosure of all of its features. The invention now disclosed may in one embodiment or parts formed within an embodiment or added to a embodiment provide advantages or solve conditions or effects of thermal expansion and contraction, corrosion, component protection, dielectric and galvanic actions, physical protection, wear protection, identification of the invention and a conduit, vibrations or shock, ease of installation for supporting, securing or guiding, and attaching conduits as disclosed in descriptions or illustrations throughout this document.

The main embodiment of the invention or device can be made of non metallic elastomeric material or similar, which can be made of recycled material, which may have other elements when desired for attachment, marking and labelling, protection and lighting. The device is used as a support for supporting, protecting and identifying conduits and components as previously described in the Abstract. This invention will have allowances for expansion and contraction without the use of moving parts. Expansion and contraction is managed by or within the unique engineered support conduit area or conduit cradle as mentioned in the description. The support area is designed with specific engineered tolerances based on the coefficient of thermal expansion and contraction of conduit materials and the invention. However, some models may appear without a conduit cradle area allowing for a conduit to be directly placed on top of the invention. The shape and size of the conduit area is a factor of risk assessment and engineering tolerances surrounding the conduit; the conduit support area may in other words be slightly larger with a specific contact footprint for conduit support within the embodiment while providing allowances for multi-directional expansion and contraction of the conduit supported by the invention. The tolerances formulated are dependent upon the size and material of the conduit being supported and risk assets activities or functions of the invention not based solely on the rate or coefficient of expansion for any particular conduit material which may include allowances for air circulation around the conduit, the invention and surrounding areas. The shape and size of the conduit support area may differ when required dependent upon those factors listed previous as well factors which can be site specific. The invention will not have metallic materials in contact with the conduits however metallic materials are given allowance for depending upon installation activities. Metallic material may be part of the invention or provided as an option to the installer. The metallic parts may include but are not limited to, a base, a base clip, a wedge, screws or bolts, a slide, top clip or cover or conduit protector. The invention can be secured to other structures by the use of conventional screws, threaded rod, bolts or adhesives alone or in conjunction with those conventional means described above. Areas for attachment can be pre set by means of hole(s) part way through or entirely through or simply marked or labelled “attachment point”, “anchor point” or in language that will be familiar and understood by the installer which may only include instructions wherein numbering or lettering is used to describe the locations. However, options to the installer are left to those trained to locate the specific positions of attachment based on the experience and need of the installer to where no instruction is provided.

The invention will have allowances for one, or more than one conduit to be supported within one embodiment where means of conduit attachment to the invention may require no tools to complete. The conduit may simply be inserted into the invention by way of an insert opening or passing the conduit through a pre-sized opening where protection of the conduit can be accomplished by the material of the main embodiment at each side of the conduit. The insert opening may have a cover for attachment after the conduit is placed inside the conduit support area. The cover and invention may include a structural fatigue design wherein the cover and or the invention can release a conduit if undue stresses occur. The cover as described can be fitted with lighting and conduit protection methods further to or in addition to those described for side protection. Options for protection and the method used to provide this protection can also be used to ensure other similar devices stay within installation distance tolerances.

The invention can incorporate other convention means of direct attachment for conduits above or beside when conduit separation is required for such installation as gas conduit separation from electrical conduits or simply to save space. This separation of conduits may also isolate conduits from one another creating air gaps impairing temperature transfer from conduit to conduit or from conduit to building or similar.

The invention or device may have a flat bottom to rest on top of flat surfaces or be placed on objects such as roof blocking or be notched to be placed over smaller objects with additional options including those with strut like adaptions made within the device to be pushed, slid or clamped into u-channel strut. Discrimination is not given to the numbers of conduits or the size of conduits held or supported within the invention. However, a typical length that could be anticipated would not be longer than three feet which may include areas within the main embodiment where break away sections are provided between areas where a conduit is supported, this may allow for longer sections to be separated with ease. The size of the invention is based on the size of the conduit being supported or held within. The typical largest size of a conduit could be Nominal Pipe Size 3 inch, however special considerations are given to larger sized conduits and are to be considered within the scope.

The inventions can be installed in any position but it is the intent that with larger conduits the invention be installed with the base at the bottom with the conduit insert opening facing upward.

The color of the invention is expected to be black, however optional colors are possible depending on the installation requirements. Such examples could be those set forth by codes and standards followed by jurisdictional requirements which could include yellow for natural gas or red for fire suppression. The invention can be color coded as mentioned with additional means of identification by numbering, lettering or labelling which are dependent upon the use. These can be provided as attachments to the invention including push pins or push inserts. Identification is also possible by where stored energy lighting is provided within the invention or within the inventions slide or clip or cover. For areas of snow fall identification flagging can be provided and inserted into parts of the invention when desired.

The invention, as described is for use as a support, attachment piece, hanger, adaptor or component including roof supports to where adaptation can be accommodated for existing supports by either placing on top, inside or around any support base provided without being directly placed on the roof surface but on a support already on the roof surface. However, direct placement on a roof surface is possible with such certain models if so desired and sense can be made by the installer or user. The invention also may be used inside or around or place directly on where sense can be made for attachment to objects like or similar to roof trusses, u channel, strut, beams, electrical panels, machinery or similar for the installation as described or illustrated within other aspects of this disclosure.

The invention may have models where an opening or openings between the support areas have allowance for inspection or testing of conduit components. The invention can incorporate specialized specific types such as “Double Blocks” for couplings, valves, junction boxes, regulator or similar when required and “Single Blocks” configured to accommodate support where chosen, “T Blocks” for angles that form tee connections and “90 Block” for perpendicular changes in direction. Regardless of the configuration of the device or invention components have inspection and testing areas built within the device and support will be within close proximity to a component at joining points. The lowered area of the invention can accommodate for lighting and storage of components required for the purpose of lighting, however, lighting may be attached wherever needed on the main embodiment of the device which would include single block styles where no lower area is formed as part of the device.

Alterations and further modifications of the inventive features described within this document which would normally occur to one skilled in the relevant art and having possession of this disclosure, are to be considered within the scope of the invention claimed. A portion of the disclosure of this patent document contains material which is subject to copyright protection as such those including but not limited to “Single Block” “Double Block” “90 Block” and “T Block” are reserved by the named inventor appearing within this document.

### BRIEF DESCRIPTION OF THE DRAWINGS

Reference is made herein to the accompanying drawings or illustrations, which are not drawn to scale.

FIG. 1 and FIG. 1a are exploded front views of the present invention or side views in relation to a perpendicular support member in relation to a conduit.

FIG. 2 is a perspective view of the present invention illustrating the flat bottom attachment.

FIG. 3 is a perspective view illustrating the flat bottom attachment to where no discrimination is given to the number of conduits that may be in one embodiment of the present invention.

FIG. 4 is a perspective view illustrating a clip bottom attachment.

FIG. 5 is a perspective view illustrating the clip bottom attachment to where no discrimination is given to the number of conduits that may be in one embodiment of the present invention.

FIG. 6 is a perspective view of the present invention illustrating the solid grooved bottom attachment.

FIG. 7 is a perspective view illustrating the solid grooved bottom attachment to where no discrimination is given to the number of conduits that may be in one embodiment of the present invention.

FIG. 8 is a perspective view illustrating the open grooved bottom attachment.

FIG. 9 is a perspective view illustrating the open grooved bottom attachment to where no discrimination is given to the number of conduits that may be in one embodiment of the present invention.

FIG. 10 is a perspective view illustrating the universal grooved bottom attachment.

FIG. 11 is a perspective view illustrating the universal grooved bottom attachment to where no discrimination is given to the number of conduits that may be in one embodiment of the present invention.

FIG. 12 is a perspective view illustrating a lowered upper plateau of a main embodiment's top and description to where allowance is made for combination of bases.

FIG. 13 is a prospective view illustrating a lowered upper plateau to where no discrimination is given to the number of conduits that may be in one embodiment of the present invention. And where allowance is made for combination of bases.

FIG. 14 is a perspective view illustrating the flat bottom attachment base and a closure clip.

FIG. 15 is an exploded perspective view illustrating a support block to where attachment is made of the present invention with the flat bottom.

FIG. 16 is a perspective view illustrating the completed movements of FIG. 15.

FIG. 17 illustrates an exploded perspective view illustrating the flat bottom attachment to a support block where the top of the support has a u-channel strut.

FIG. 18 is a perspective view illustrating the completed movements of FIG. 17.

FIG. 19 is a perspective view illustrating the open grooved bottom attachment base.

FIG. 20 is an exploded perspective view illustrating the open grooved bottom attachment base with a u-channel strut including the use of a securing tapered wedge.

FIG. 21 is a perspective view of the securing tapered wedge with a pull tight draw mechanism.

FIG. 22 is a perspective view illustrating the position of the tapered wedge after insertion.

FIG. 23 is a perspective view illustrating the completed movements of FIG. 20.

FIG. 24 is a perspective view illustrating the open grooved bottom attachment over an object.

FIG. 25 is a perspective view illustrating a clip bottom attachment over an object.

FIG. 26 is a prospective view illustrating the wrap around bottom attachment over an object.

FIG. 27 is an exploded perspective view of components for use in FIG. 28 through FIG. 30.

FIG. 28 is a perspective view illustrating a protection method.

FIG. 29 is a perspective view illustrating a protection method on a support block.

FIG. 30 is a perspective view illustrating the protection covers installed including marking means for the conduit.

FIG. 31 is an exploded perspective view illustrating a cover protector and protection platform.

FIG. 32 is a perspective view illustrating a cover protector and protection platform with an elongated side of a protection platform and lights on the cover protectors.

FIG. 33 is a perspective view illustrating the main embodiment of the invention without the cover protector and protection platform.

FIG. 34 is a perspective view illustrating the cover protector and protection platform installed over the main embodiment of the invention illustrating a conduit being protected.

FIG. 35 is an exploded perspective view illustrating the lower plateau of the main embodiment with cover protector, protection platform, conduit base support and underside protection of a conduit.

FIG. 36 is a perspective view illustrating physical protection using only the protection platforms.

FIG. 37 is a perspective view illustrating physical protection with side and top protection platforms including conduit identification and covers including lighting.

FIG. 38 is a front view illustrating the conduit holding area and the top insert area with an opening for a protection method.

FIG. 39 illustrates an exploded perspective view of one means to provide a protection slot to accept a protection platform incorporated within a main embodiment.

FIG. 40 is a front view illustrating the conduit holding area for cover slides.

FIG. 41 is a perspective view illustrating a main embodiment or “Insert Single Block”.

FIG. 42 is a perspective view illustrating a main embodiment or “Insert Double Block”.

FIG. 43 is a perspective view illustrating a main embodiment or “Double Block”.

FIG. 44 is a perspective view illustrating a main embodiment or “Insert 90 Block”.

FIG. 45 is a perspective view illustrating a main embodiment or “90 Block”.

FIG. 46 is a perspective view illustrating a main embodiment or “Insert T Block”.

FIG. 47 is a perspective view illustrating a main embodiment or “T Block”.

FIG. 48 is an exploded perspective view illustrating a main embodiment or “Insert Single Block” with a cover plate and conduit.

FIG. 49 is a perspective view illustrating the completed movements of FIG. 48.

FIG. 50 is a perspective view of a main embodiment or “Insert Single Block” with a conduit inserted into the main embodiment and a conduit attached to the top of the main embodiment.

FIG. 51 is a perspective view illustrating a main embodiment or “Insert Single Block” with a conduit inserted into the main embodiment and a conduit attached to the top of the main embodiment at a higher elevation with the use of threaded rod.

FIG. 52 is an exploded perspective view illustrating a main embodiment or “Insert Double Block” with a cover plate, lighted area, structural attachment area, component and a conduit inserted into the main embodiment.

FIG. 53 is an exploded perspective view illustrating a main embodiment or “Insert Double Block” with a cover plate, cover clip, lighted area, structural attachment area, component and a conduit inserted into the main embodiment with a conduit elevated above the main embodiment.

FIG. 54 is an exploded perspective view illustrating a main embodiment or “Insert Double Block” with a protection platform, cover clip protector, component and a conduit inserted into the main embodiment.

FIG. 55 is a perspective view illustrating the completed movements of FIG. 54.

FIG. 56 is a perspective view illustrating a main embodiment or “Double Block” with a conduit attached to the top of the main embodiment.

FIG. 57 is a perspective view illustrating a main embodiment or “Double Block” illustrating a conduit where attachment of a conduit is made using u-channel and a clip.

FIG. 58 is a perspective view illustrating a main embodiment or “Double Block” illustrating conduit attachment using threaded rod elevating u-channel.

FIG. 59 is an exploded perspective view illustrating a main embodiment or “Insert 90 Block” with a lighted area, structural attachment area, component, a conduit inserted into the main embodiment and a cover plate.

FIG. 60 is a perspective view illustrating a main embodiment or “90 Block” with a conduit attached to the top of the main embodiment.

FIG. 61 is a perspective view illustrating a main embodiment or “90 Block” with a conduit attached to the top of the main embodiment.

FIG. 62 is a perspective view illustrating a main embodiment or “90 Block” with an elevated conduit attached to the top of the main embodiment using threaded rod.

FIG. 63 is an exploded perspective view illustrating a main embodiment or “Insert T Block” with a cover plate, conduit, component, lighted area and structural attachment area.

FIG. 64 is a perspective view illustrating a main embodiment or “Insert T Block” with a cover plate, a conduit inserted into the main embodiment and a conduit supported by the main embodiment but elevated above the main embodiment with the use of threaded rod.

FIG. 65 is a perspective view illustrating a main embodiment or “T Block” with a conduit attached to the top of the main embodiment.

FIG. 66 is a perspective view illustrating a main embodiment or “T Block” with a conduit attached to the top of the main embodiment.

FIG. 67 is a perspective view illustrating a main embodiment or “T Block” with an elevated conduit attached to the top of the main embodiment using threaded rod.

FIG. 68 is a plan view illustrating a main embodiment or “Insert Single Block”

FIG. 69 is a plan view illustrating either main embodiment “Insert Double Block” or “Double Block”

FIG. 70 is a plan view illustrating either main embodiment “Insert 90 Block” or “90 Block”

FIG. 71 is a plan view illustrating either main embodiment “Insert T Block” or “T Block”

FIG. 72 is a plan view illustrating the top of an upper ridge in where the upper ridge may be of any embodiment.

FIG. 73 is a plan view illustrating the bottom or underside of an upper ridge in where the upper ridge illustrated can be of any embodiment.

FIG. 74 is a plan view illustrating the top of an upper ridge in where the upper ridge may be of any embodiment.

FIG. 75 is a plan view illustrating the bottom or underside of an upper ridge in where the upper ridge illustrated can be of any embodiment.

FIG. 76 is a side view illustrating a cover plate complete with push pins.

### DETAILED DESCRIPTION

In the following description with the use of the figures or illustrations, numerical and or alphabetical references may refer to similar components and elements. The components, elements and or embodiments may also be identified numerically, alphabetically, or a combination of both described or configured to point to one element, component or embodiment; where this appears, the meaning may be for all that appear as illustrated and described where sense can be made. The embodiments, components, configurations and materials illustrated in the figures or described within this description are preferred embodiments only and are given solely for explanation purposes. Where similar depictions or drawings are made these similar descriptions where sense can be made are to be understood without duplication of such descriptions for each Illustration. Descriptions of well-known components are omitted so as to not unnecessarily obscure the principle features of the invention. It is noted that combinations of main embodiments and the means of attachment are interchangeable and depictions within the drawings or illustrations do not limit the usage of other main embodiments, as such, drawings are basic forms of each. It should be understood that no limitation of the scope of the invention is thereby intended. Terminology used herein is for the purpose of describing embodiments only and is not intended to be limiting of the invention. As used herein, the use of singular terms may include plural or plural may be singular where sense can be made. No discrimination is given to the design for the numbers of repetitions of conduit 6 attachments, or other descriptions, this is shown in dotted extension 34 throughout as a continuation of noted remarks in a mirror like fashion.

The present invention and the components of the invention may be fabricated of any suitable materials, including plastics, composites, metals and recycled materials, and may be fabricated using suitable techniques, including molding, casting, machining or similar to achieve the results required.

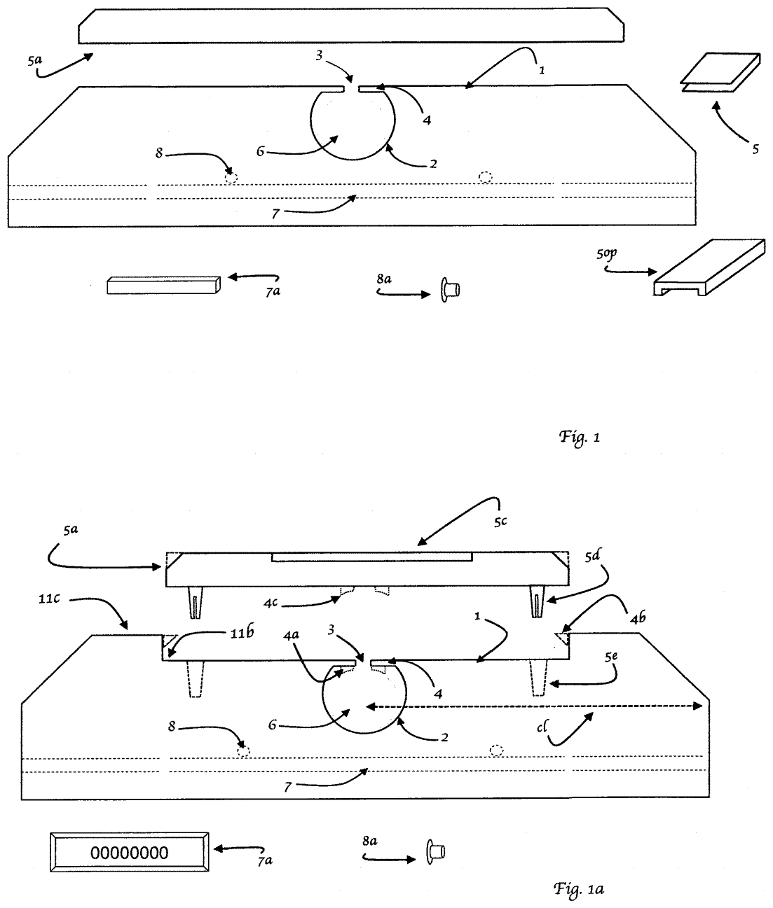

Referring now to the figures and the inventions which are composed of several different elements or components completing one embodiment depending on the use or function. FIG. 1 is a front view illustrating a conduit 6 supported within the main embodiment 1 of the conduit insert invention which is held or supported in the uniquely engineered conduit cradle 2 (as described in the summary as conduit area) which may have a top section of pliable overlaying materials 4 which may be formed as part of the main embodiment 1 which is intentionally separated by a void or conduit insert opening 3. The overlaying material 4 may be straight cut or have an angular shape where the opposing ends facing inward are discontinued. The discontinued overlaying material 4 is intentionally done so that the conduit 6 may have a shorter path of travel to its final installed position within the conduit cradle 2. The conduit 6 is to be inserted without the use of tools through the conduit insert opening 3 even when ambient temperatures are not favorable. This overlaying material 4 when moved in an inward direction towards the conduit cradle 2 allows the conduit 6 to be inserted with ease by defecting the overlaying material 4 in a downward manner. It is now mentioned that overlaying material 4 is optional and may in some cases not be formed in part or in whole of the device(s) or a main embodiment. After the action of inserting the conduit 6 through the conduit insert opening 3 the overlaying material 4 returns to its original position. The overlaying material 4 is not anticipated to hold fast the conduit 6 in designs that are engineered with expansion and contraction considerations. The shape of the conduit cradle 2 is noticeably not round and this feature is intentional for designs when required expansion and contraction considerations are given, however, the conduit 6 could be of the same size as the conduit cradle 2. The overlaying material 4 may not be the only holding member of the main embodiment 1 to where the conduit 6 is enclosed. The main embodiment 1 may have a cover plate 5a, cover clip 5op or cover clip 5 for attachment over the insert opening 3 or be left uncovered without the cover plates 5 and 5a or similar in FIG. 1a. FIG. 1 further illustrates attachment areas 8 which may be drilled or formed hollow at the time of manufacturing or marked or labeled or similar. These attachment areas 8 can be filled after installation with push marking pins 8a which also can function as a marking or labelling system which could be words, letters, numbers, shapes with words, colors or letters, bar coding, numbers or similar embossed, cast or formed as part thereof. The use of stickers or other could be adhered to the push marking pins 8a for the purpose of marking or labelling also. A notched area 7 which may be any length or size is illustrated now extending the entire length of the main embodiment 1 illustrated as a dotted line which is for the purpose of marking and labelling where more precise labelling is required in such models that provisions are made in this manner. Such means for marking and labelling could be provided as a push tab 7a and will perform and be created in a similar manner as those described for the push marking pin 8a. The notched area 7 may further function as a support member or groove for attachment into u-channel strut which will become more clear and obvious as the descriptions and illustrations continue throughout other figures and explanations including those of FIG. 6 and FIGS. 19 through 23. Marking and labelling as described within FIG. 1 is similar throughout the writing and from now when not shown or described elsewhere will be similar to those described within this FIG. 1 or where other mention is made.

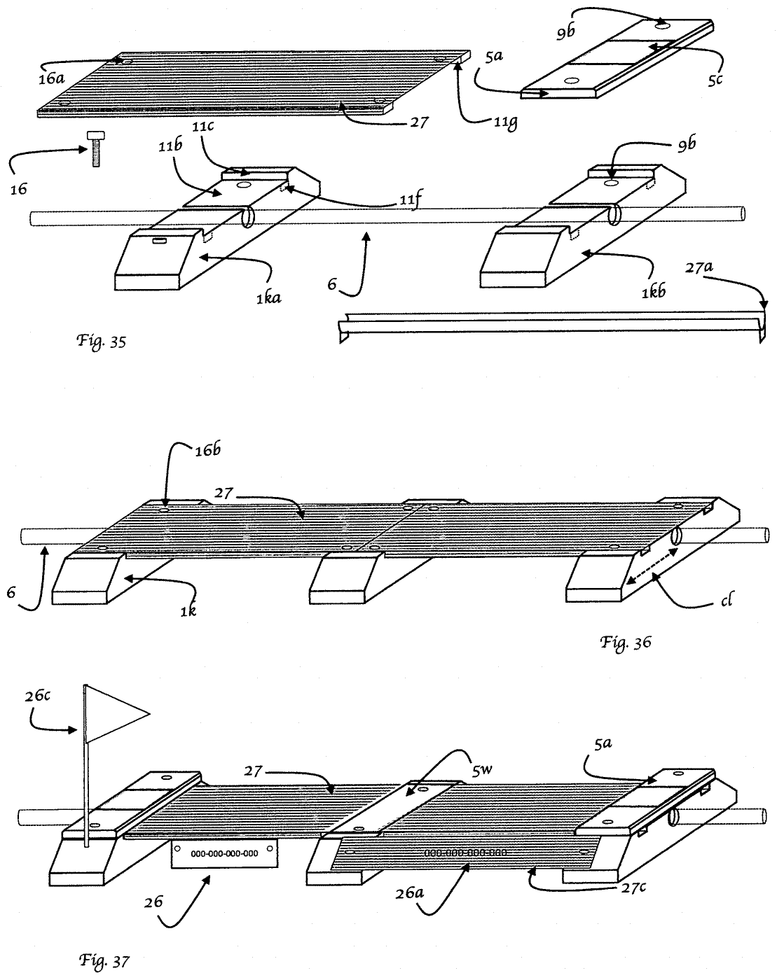

FIG. 1a as illustrated provides the same basic components and functions as FIG. 1 for the elements of the conduit 6, conduit cradle 2, attachment area 8, overlaying material 4, conduit insert opening 3, notched area 7, push tab 7a and push marking pins 8a but now representation is illustrated for overlaying vibration material 4a which may be used as a vibration dampener or similar which can be in contact with the conduit 6 where it may also function as a pressure release for the cover plate 5a, a cover plate 5a which may include as an option the overlaying vibration material 4a as part of the cover plate 5a when overlaying material 4 is not part of the main embodiment 1 and a recessed lower plateau 11b which is a lower elevation change in comparison to the higher plateau 11c of the main embodiment 1. This lower plateau 11b can be formed as part of main embodiment 1 to allow for a recessed cover clip 5a and other protection methods that will become more obvious in other illustrations including those of FIGS. 35 through 37. FIG. 1a also includes a light 5c which can be formed in part or in whole of the cover plate 5a. The light 5c could also utilize means of reflective material when required alternate to a light 5c or similar. A holding tab 4b is now shown which represents an option of providing within the higher plateau 11c an area to slide the cover plate 5a into without the use of tools to secure the cover plate 5a, this option is also illustrated with use of push pins 5d where the push pins 5d can be inserted and held by friction or with outward ridges at the base of the push pins 5d into push holes 5e within the main embodiment 1. This is provided as an option for where physical attachment to a structural object could be compromised by extreme movement or fatigue of the attached object to where the main embodiment 1 or conduit support is placed allowing for the cover plate 5a to be dislodged and the conduit 6 to be released. Centerline cl is shown for reference to the length from the centerline of the conduit cradle 2 to the outside of the embodiment 1 which may be used for installation purposes where the known length can be adopted as a measuring device to aid in conduit 6 being installed in straight or parallel lines to each other. This distance from the center line of the conduit cradle 2 also now illustrates side physical protection to the conduit 6 wherein the main embodiment 1 has a thickness engineered to withstand physical impact, this protection is also provided by design if more than one conduit 6 is accommodated in one main embodiment 1. Push pins 5d are described as cylindrical tapered pins which may be formed in part or in whole of the cover plate 5a or similar for insertion into push holes 5e within the main embodiment 1 to secure the cover plate 5a to the main embodiment 1. The push pins 5d will will have a void or voids as part of the push pins 5d extending from the bottom tip to the underside of the cover to allow for inward deflection of the pin material when pressed into the recessed area or push holes 5e of the main embodiment. When extreme external forces are imposed on the main embodiment 1 or conduit 6 the push pins 5d can become dislodge from the main embodiment 1 releasing the cover plate 5a and in turn the conduit. This action of dislodging the cover plate 5a can be critical in such designs where a conduit 6 needs to be released form the main embodiment 1 during times where the structural support the main embodiment 1 is attach has critical failure; this might occur during an earthquake or similar.

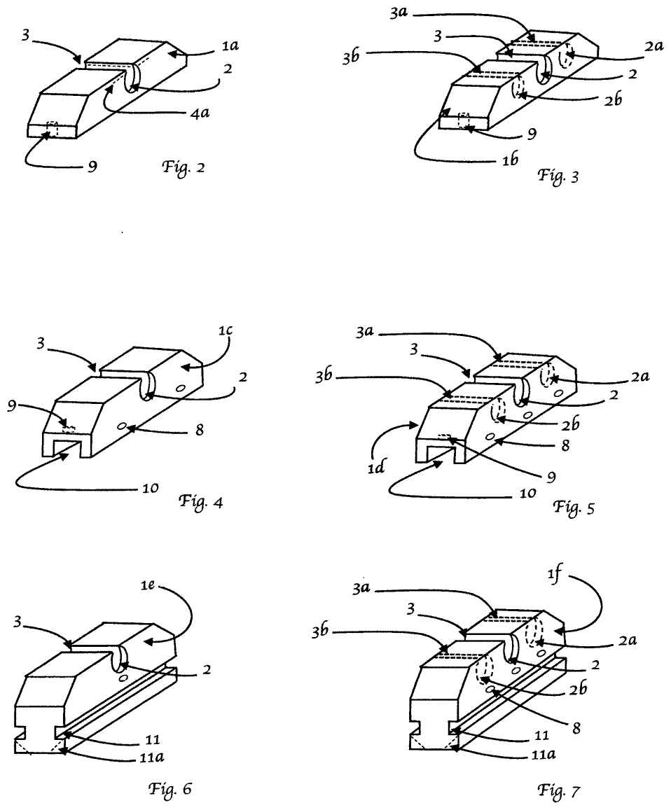

FIG. 2 now illustrates the main embodiment as 1a which later will become apparent with the introduction of similar main embodiments all starting with 1 but with the addition of letters following the number. This change of main embodiments is intentional for recognition of the base or attachment means in which the main embodiment transforms to accommodate attachment means. Further to describe FIG. 2 which now illustrates the main embodiment 1a with an insert point for top clip 5 of FIG. 1 which may be slid through or into slide clip insert 4a opening or slot which is shown above the conduit cradle 2 and under the insert opening 3. This top clip 5 of FIG. 1 can be reflective material which also may function as a measuring device for attachment of screws or similar into the attachment area 9 when the design or instructions have the installer leaving the attachment screws slightly elevated allowing for movement. The main embodiment 1a shows attachment area 9, this area can be as describe as a drilled or formed hollow opening at the time of manufacturing which may be provided for the purpose of attaching the main embodiment 1a to a structure. The attachment area 9 can provide for expansion and contraction when the hole is elongated. This attachment area if not formed in whole at the time of manufacturing can be marked or labeled or similar where notification is given to the installer for its purpose.

FIG. 3 is illustrated showing the same attachment means or flat bottom as the main embodiment 1a of FIG. 2 but now with more than one conduit cradle 2 in the main embodiment 1b where no discrimination is given to the numbers of conduit cradles 2 that might be within one main embodiment 1b. The main embodiment 1b can have multiple conduit cradles sized equally in circumference, however the size of conduit cradle 2 may differ as shown in conduit cradle 2b, this is probable in such conduit systems similar to potable water lines where the water system includes a hot line, a cold line, and a recirculation line wherein the hot and cold lines could be equal in size shown as conduit cradles 2 and 2a but having a recirculation line sized smaller held within conduit cradle 2b; these are given as examples only, and other similar examples could be predicted where conduit size changes are needed. Conduit cradles 2, 2a and 2b could replicate in numbers depending on the installation. Insert openings 3, 3a and 3b are shown in relation to the conduit cradles 2, 2a and 2b wherein the same previous described actions of insertion are required for a conduit to be inserted through insert openings 3, 3a and 3b. Attachment area 9 is shown at the ends of the main embodiment 1b, however it is conceivable that with longer main embodiments 1b composed of multiple conduit cradles 2 these attachment areas 9 could be more numerous and allowances within the conduit cradle 2 bottom are given for addition attachment areas 9. Small holes may be added in the bottom of any conduit cradle 2 for this purpose, these holes may also function as drainage holes for water or condensate or similar.

FIG. 4 illustrates a void 10 within the main embodiment 1c at the bottom for the purpose of fitting the main embodiment 1c overtop of other surfaces which could include 2×4 or 2×6 or similar wood planking or studs, strut u-shaped channel or similar rectangular objects. Attachment areas 8 are now shown for the purpose of side attachment to the similar above mentioned objects also including attachment area 9 which are for the purpose of downward attachment. Both attachment areas may be drilled or formed hollow at the time of manufacturing or marked or labeled or similar for the installer to drill out. Attachment areas 8 can be filled after installation with push pins 8a of FIG. 1 and FIG. 1a which also function as a marking or a labelling system which could be words, letters, numbers, shapes with words, colors or letters, numbers, bar coding or similar embossed, cast or formed as part thereof as described in FIG. 1. The conduit insert opening 3 and conduit cradle 2 are shown with the same functions as those previously describe.

FIG. 5 is illustrated as a replication of elements previously described in FIG. 3 as attachment area 9, conduit cradles 2, 2a and 2b and insert openings 3, 3a and 3b. The main embodiment 1d now shows the same void 10 as described in FIG. 4. FIG. 5 is shown now with attachment areas 8 for the side attachment a described in FIG. 4. With multiple conduit cradles 2, 2a and 2b as described in FIG. 3 the importance of the marking systems described previously becomes apparent. Attachment areas 8 complete with the push pins 8a of FIG. 1 could be attached inside the attachment area 8 providing identification for the conduits being supported within any given conduit cradle 2, 2a and 2b. It is possible for these attachment areas 8 to be more numerous than the actual need for attachment locations to an object, however these attachment areas may still be part of the main embodiment 1d strategically placed for only the purpose of identification with the use of the push pins 8a of FIG. 1.

FIG. 6 illustrates the main embodiment 1e now with a notched groove 11 which runs the entire lateral length of the main embodiment 1e with further proximity to the bottom. This notched area may be sized exactly or within given tolerances to allow for the sliding or pushing of the main embodiment 1e inside a u-channel strut. An arrow shaped end or similar may be formed within the base of the main embodiment 1e shown as angle cut 11a for the purpose of providing less resistance for direct placement downward into u-channel strut when the u-channel strut is upright or the open end is facing the main embodiments 1e bottom. The main embodiment 1e may either be pushed inside a u-channel strut or slide into such strut when the outward ridge of the u-channel strut matches up or line up with the inward notched groove 11 of the main embodiment.

FIG. 7 illustrates a main embodiment 1f to where now the same notched groove 11 is shown but in combination with multiple conduit cradles 2, 2a and 2b and insert openings 3, 3a and 3b this is again given as an example of more than one conduit cradle 2 and is not intended to limit the numbers or size of either. The same base of the main embodiment 1f and angle cut 11a and notched groove 11 complete or performs the same duty and or function as described in FIG. 6. The main element change of this figure is the inclusion of push pin openings 8b. The push pin openings 8b are formed in part or in whole of the main embodiment 1f for the purpose of attachment of push pins 8a of FIG. 1 only as attachment to objects is not from the side for this main embodiment 1f. The intention is that the push pins 8a of FIG. 1 are to be inserted into the push pin openings 8b of this figure for the purposes as described in FIG. 1 as a marking or labelling system which could be words, letters, numbers, shapes with words, colors or letters, numbers or similar embossed, cast or formed as part thereof. The use of stickers or other could be adhered to the push pins 8a of FIG. 1 for the purpose of marking or labelling also.

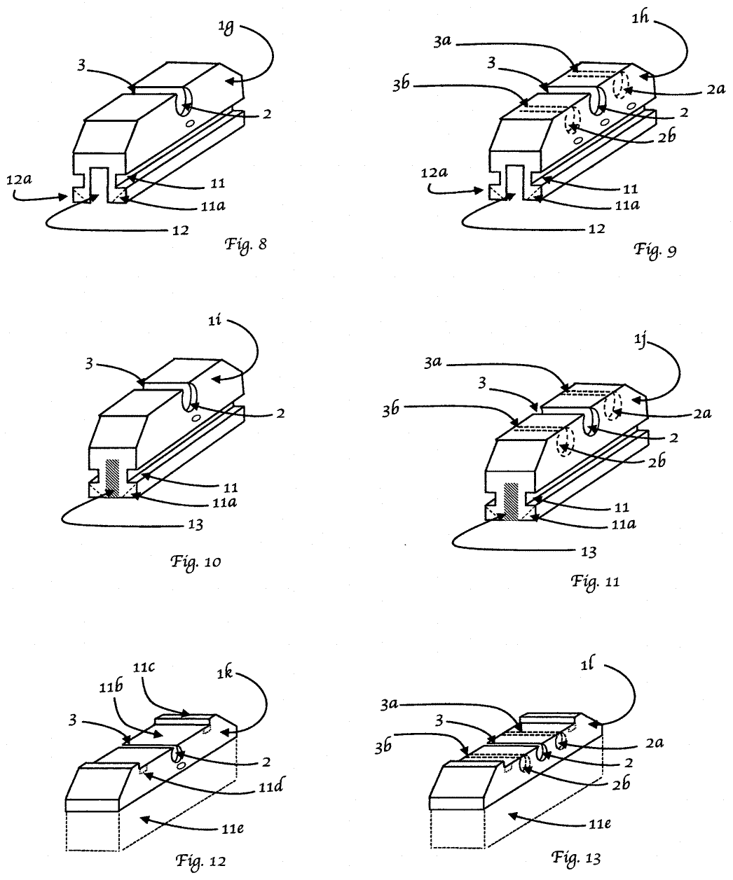

FIG. 8 is a main embodiment 1g showing a conduit cradle 2 and insert opening 3 with a base of the main embodiment 1g similar to that shown in FIG. 6, except that the base is now open continuously throughout the main embodiment 1g illustrated at the base opening 12. The base opening 12 is provided or given as an allowance for ease of installation into u-channel strut where the base opening 12 allows for inward movement of the base legs 12a when inserted into u-channel strut. After the installation, when the inward notched groove 11 fits into the u-channel strut and around or mated with the u-channel strut outward groove the base legs 12a that were deflected inward at the initial time of installation return to the original resting state locking the main embodiment 1g into the u-channel strut. Marking and labelling will be accounted for within the main embodiment as described in the previous figures but is not shown in FIG. 8, this is intentional. The base legs 12a may be formed where the bottoms have an angle cut to allow for ease of installation as illustrated in angle cut 11a.

FIG. 9 similar to FIGS. 3, 5 and 7 illustrates multiple conduit cradles 2, 2a and 2b and insert openings 3, 3a and 3b now for main embodiment 1h. The narrative or descriptive writing will be similar to those given previous as is the intention of those noted above. Base legs 12a, base opening 12 and angle cut 11a function in relation to or with the notched groove 11 and u-channel strut as described previous.

FIG. 10 now shown with a main embodiment as 1i with a knock out 13 that when removed provides and acts like the base opening 12 of FIG. 8. The knock out 13 when intact and not removed functions and acts like the solid base of FIG. 6. This intentional knock out 13 provides features of two bases within one base of the main embodiment 1i. Conduit cradle 2 and insert opening 3 are typical as described elsewhere as is the notched groove 11 and angle cut 11a.

FIG. 11 as shown provides multiple conduit cradles 2, 2a and 2b and insert openings 3, 3a and 3b without discrimination to numbers or sizes as described previous. The main embodiment 1j is shown now with the same knock out 13 as in FIG. 10 with notched groove 11 and angle cut 11a also described previous.

FIG. 12 shows a main embodiment 1k with a noticeable lower top section or lower plateau 11b with raised ends or higher plateau 11c. The lower plateau 11b can be formed within the main embodiment 1k for the purpose of recessing the cover plate 5a of FIG. 1a. The recessed cover plate 5a of FIG. 1a is anticipated to have a level top with the higher plateau 11c providing a streamline feature and a shallower or lower profile. This lower plateau 11b as shown also acts as a holding area for cover plate 5a of FIG. 1a and or platform 27 of FIG. 35 which will be noticed and become apparent in later FIGS. 35 through 37 along with the lower plateau notch 11f of FIG. 35. The main embodiment 1k has multifunctional means of attachment or bottoms or bases which is shown as multi base 11e in where any of the previous bottoms or bases shown are also included within main embodiment 1k, these are represented in FIGS. 2,4,6,8, and 10. Conduit cradle 2 and insert opening 3 are shown with the same representation as those described previous.

FIG. 13 illustrates the same lower plateau 11b and higher plateau 11c of the main embodiment 1k of FIG. 12. Now illustrated are multiple conduit cradles 2, 2a and 2b and insert openings 3, 3a and 3b of main embodiment 1l which are shown again without any discriminations as previously described in the above detailed description of the illustrations, including now the same multi base 11e.

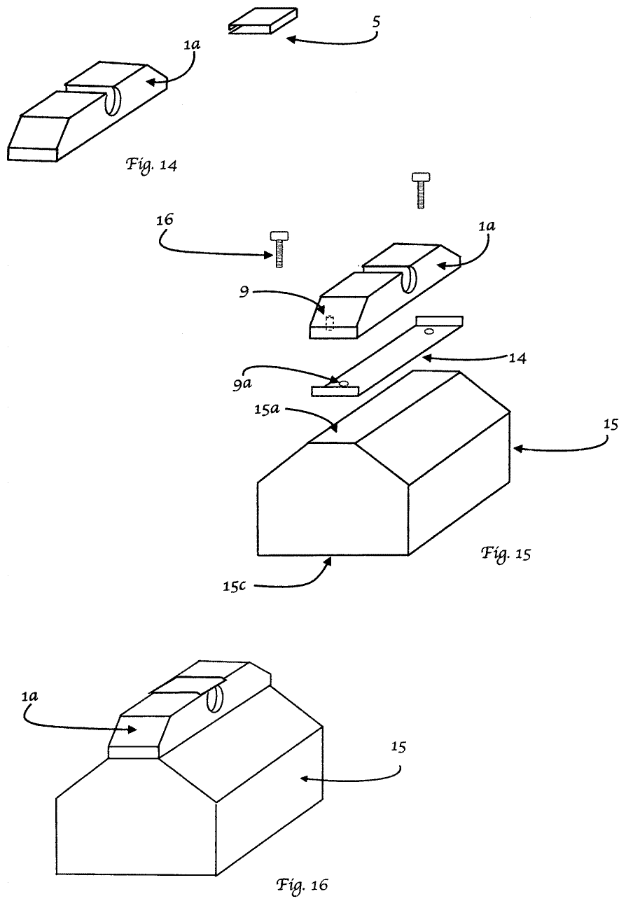

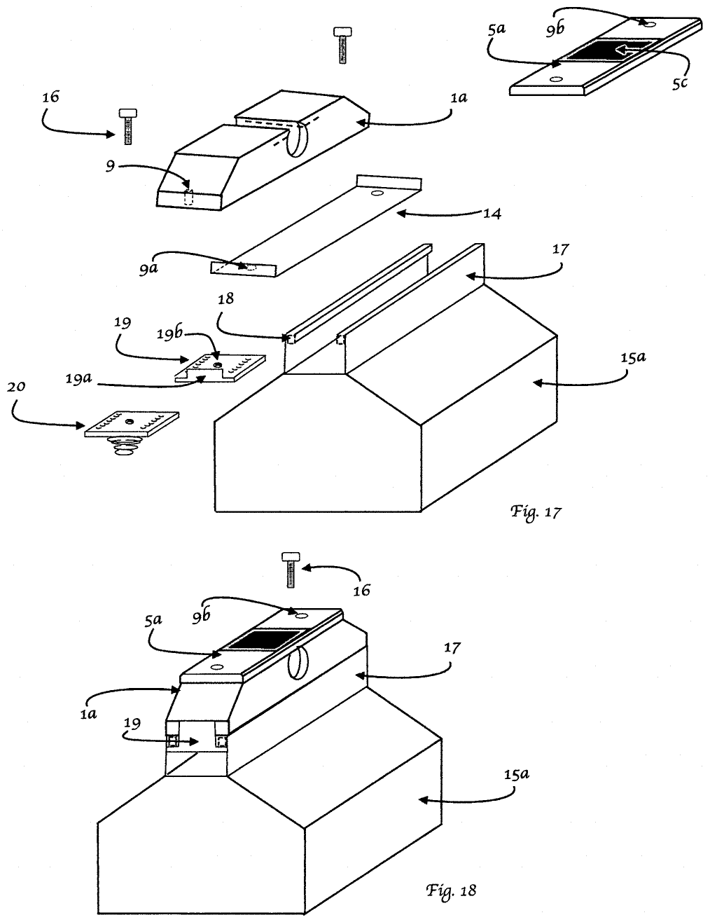

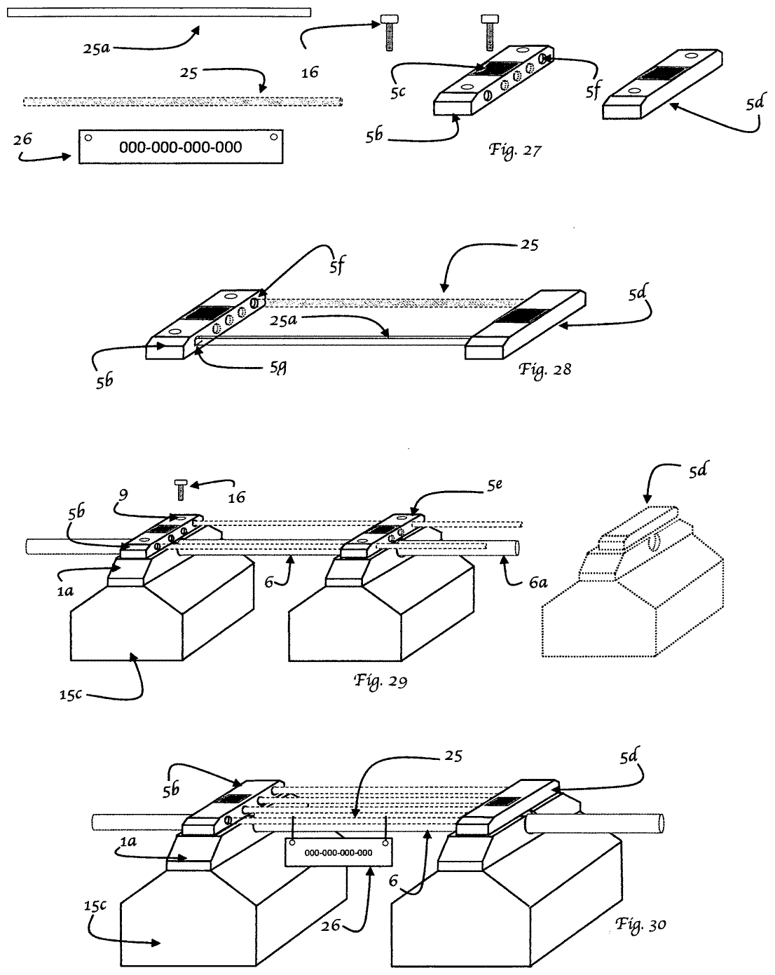

FIGS. 14, 15 and 16 illustrate the attachment of the main embodiment 1a starting from FIG. 14 which is a main embodiment 1a and cover plate 5a. FIG. 15 is an exploded perspective view of the main embodiment 1a to where attachment elements are being shown in what could be interpreted where attachment bolt hardware 16 could be inserted through attachment area 9 and again through an optional base plate 14 through attachment area 9a into the top area 15a of a block type of support 15 where the bottom area 15c could be resting or placed on a roof surface. The cover clip 5 of FIG. 14 could be reflective and an option is given for cover plates 5a of FIG. 1b wherein a light is also optional for areas when lighting is required or desired, this is also shown in FIG. 17 and FIG. 18. Other cover clip methods such as those in later descriptions are possible when so required or needed for protection or marking as shown in such figures as FIG. 27 through FIG. 34. FIG. 16 shows a main embodiment 1a attached to a block type of support 15.

FIG. 17 and FIG. 18 perspective views showing elements of attachment to a block type of support 15a where FIG. 17 is an exploded view and FIG. 18 is what could be anticipated to be the final look of the completed attachment. Starting now with FIG. 17 and the block type of support 15a which has a u-channel strut 17 attached. The main embodiment 1a is shown with a flat bottom and will not recess or be inserted in the u-channel strut 17, this will be accomplished with the use of conventional strut clips 20 or a clip manufactured for this intention shown as base clip 19. The intention of the base clip 19 is for insertion into the u-channel strut 17 where the top sides of the base clip 19 mate with the outward elongated ridges 18 of the u-channel strut 17. A clip tab 19a is provided for ease of installation giving the installer a grasping point for holding as the bolt hardware 16 is started into the clip threads 19b. The bolt hardware 16 when inserted through the main embodiment 1a's attachment area 9 and the base plate 14 through the attachment area 9a may be threaded into the base clip 19 at clip threads 19b or similar where the bolt hardware 16 could be tightened pulling the base clip 19 upward toward the elongated ridges 18 of the u-channel strut 17 simultaneously drawing downward the main embodiment 1a and base plate 14 to where a hold fast state is provided to the u-channel strut 17. The cover plate 5a which is shown with a light 5c could be fastened to the main embodiment 1a through openings that might be provided or marked as such at attachment area 9b. FIG. 18 shows a main embodiment 1a attached to u-channel strut 17 which is attached to a block type of support 15a in where the main embodiment 1a uses the base clip 19 of FIG. 17. The cover plate 5a is now shown on the top of the main embodiment 1a to where representation is given for the bolt hardware 16 to be attached to the main embodiment 1a through attachment area 9b.

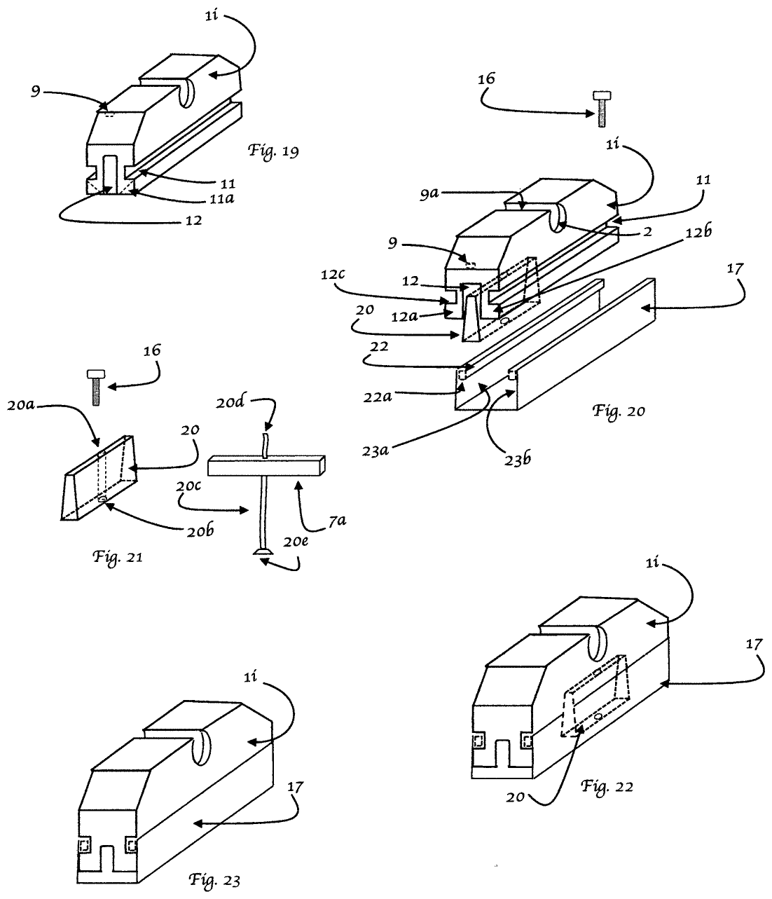

FIG. 19 through 23 now show a main embodiment 1i which could be inserted into or inside or slid into a u-channel strut 17 then secured within that u-channel strut 17 using an insert wedge 20 that is placed within the base opening 12. FIG. 19 is shown as a main embodiment 1i with attachment area 9, a notched groove 11 and angle cut 11a having a base opening 12. FIG. 20 shows an attachment means starting with bolt hardware 16 in which can be inserted through attachment area 9 which could be located at the outsides of the main embodiment 1i and or attachment area 9a which also could be provided inside conduit cradles 2 of the main embodiment 1i. Bolt hardware 16 which is or could be threaded into wedge top opening 20a of FIG. 21. Continuing now with FIG. 20 the main embodiment 1i could be slid into a u-channel strut 17 or pushed through the top of a u-channel strut 17 to where an inward deflection is assumed for base legs 12a and base legs 12b. With the main embodiment 1i pushed into the u-channel strut 17 and the inward notched groove 11 fitted into the u-channel strut 17 and around or mated with the u-channel strut 17 outward groove or elongated ridges 22 the base legs 12a and base legs 12b that were deflected inward at the initial time of installation return to the original resting state locking the main embodiment 1i into the u-channel strut 17. With the main embodiment 1i now established within the u-channel strut 17 the insert wedge 20 could be used as an extra measure to secure the main embodiment 1i. The insert wedge 20 could be placed within the base opening 12 and then tightened by means of bolt hardware 16 which could be threaded into the wedge top opening 20a (illustrated in FIG. 21) to where tightening downward within the insert wedge 20 the insert wedge 20 could be drawn upward into the base opening 12 of FIG. 20. The actions of the insert wedge 20 as described above will cause an outward force on the base legs 12a and base legs 12b toward the outside of the u-channel strut 17 at the sidewalls 23a and sidewalls 23b of the u-channel strut 17. When bolt hardware 16 is tightened the actions should also pull the base legs top 12c upward toward the elongated ridges 22 pressing the base legs top 12c against the bottom of the elongated ridges 22 at ridge bottom 22a of the u-channel strut 17 simultaneously drawing downward the main embodiment 1i. FIG. 21 as described above illustrates the push tab 7a, insert wedge 20, bolt hardware 16, wedge top opening 20a and wedge bottom opening 20b with the addition of pull tab 20c, pull tab grip 20e, pull tab top 20d. FIG. 21 is now described with an option to the bolt hardware 16 in that of a pull tab 20c. The pull tab top 20d could be fed through the wedge bottom opening 20b and through attachment area 9a of FIG. 20 with the pull tab grip 20e ending at wedge bottom opening 20b. The pull tab 20c could after installation be simply rolled over the push tab 7a and pulled upwards or away from the insert wedge 20; when the pull tab 20c is pulled to the engineered fatigue resistance release tolerance of pull tab grip 20e the pull tab 20c would release and be pulled out of the insert wedge 20 and through the main embodiment 1i and attachment area 9a of FIG. 20 securing the insert wedge 20 in place. The elements of this Figure could be assembled prior to insertion into u-channel strut 17 for installation ease. FIG. 22 shows now the main embodiment 1i secured into a u-channel strut 17 in which insert wedge 20 can be seen as a dotted outline. FIG. 23 illustrates the completed actions described above where the main embodiment 1i is installed into u-channel strut 17.

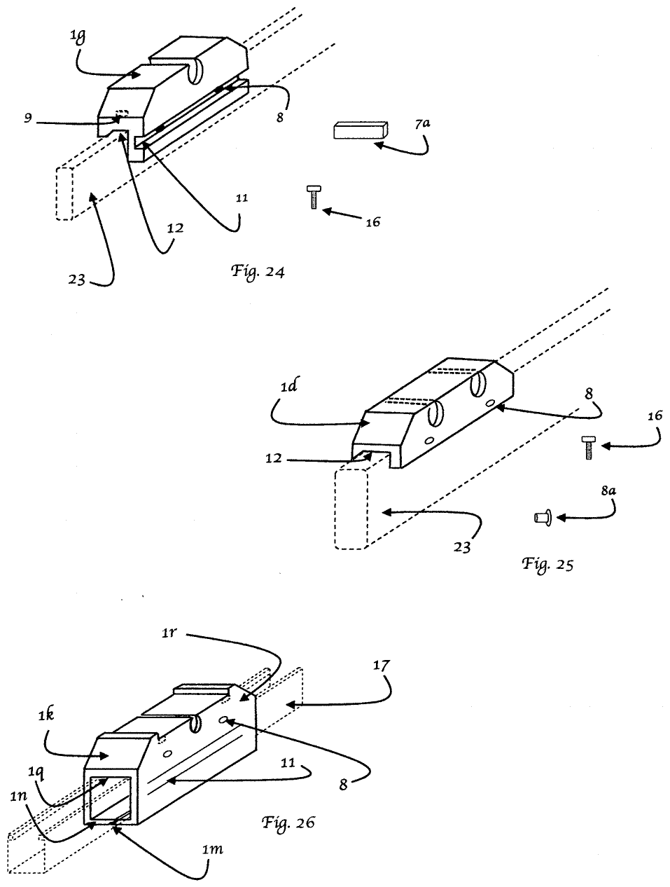

FIG. 24 illustrates a main embodiment 1g attached to or placed over a rectangular object 23 which could be metal or wood or similar. The main embodiment 1g is illustrated with a rectangular object 23 inside the base opening 12 to where secure attachment is possible by the use of bolt hardware 16 which can pass through attachment areas 9 or attachment areas 8 but friction fitting is possible to where means of conventional attachment is overruled. The notched area 11 can be provided for push tab 7a marking and labeling as described in FIG. 1. Similar marking and labelling is possible in attachment area 8 also described in FIG. 1.

FIG. 25 illustrates a main embodiment 1d attached to or placed over a rectangular object 23 which could be metal or wood or similar, which could be 2×2, 2×4, 2×6 or similar. The main embodiment 1g is drawn with a rectangular object 23 inside the base opening 12 to where secure attachment is possible by the use of bolt hardware 16 which can pass through attachment areas 8 to where marking and labelling is possible by the use of push pins 8a where description is given in FIG. 1.

FIG. 26 main embodiment 1k is illustrated now with a front side 1r and backside elongated downward to encapsulate objects which is shown within this figure as a u-channel strut 17. The extended main embodiment 1k appears now with a top bottom 1q and an outer bottom 1n which may be made of pliable material. The outer bottom 1n can have a spreadable interlock 1m that can be manipulated and opened outward to accept an object such as u-channel strut 17. Once the actions of opening and placing the main embodiment 1k over the u-channel strut 17 the manipulated material will again regain its original shape which can be pressed and locked in place with the interlock 1m and secured with a screw or similar if so desired. Marking and labelling is now possible from the sides as shown in notched area 11 or in attachment area 8 but also now from the underside of the outer bottom 1n making labelling or marking visible from the bottom of the main embodiment 1k.

FIG. 27 through 30 are illustrated giving drawing details for attachment of a protection method which is possible to be formed within the said inventions embodiment but here shown as an attachment cover clip protector 5b, 5d, and 5e. Mention was given previous to protection means in FIG. 1a and will now be described with alternate methods throughout FIG. 27 to FIG. 34. FIG. 27 is now described as cover clip protector 5b and cover clip protector 5d in which the outside end walls are solid and the inside end walls have rod hollows 5f to where square rods 25a or pipe 25, or similar can be inserted. Bolt hardware 16 can be used to attach the cover clip protectors 5b or 5d not only to the main embodiment 1a shown in FIG. 29 but also could be utilized and attached to any similar device where sense can be made for physical protection or can be used as a marking system by where signage 26 can easily be attached to one or more of the square rods 25a or pipe 25. The use of signage 26 and the inclusion of a light 5c greatly improves keeping conduit systems noticeable and protected. FIG. 28 provides a detail in which square rods 25a and pipe 25 are inserted into the corresponding square hollows 5g and rod hollows 5f where cover clip protector 5b and cover clip protector 5d are used. FIG. 29 now introduces the use of cover clip through protector 5e where it is possible to run or pass square rods 25a and pipes 25 completely through the cover clip through protector 5e. Conduit 6 is now shown under the cover clip protectors 5b and cover clip through protector 5e where conduit 6a represents the continuation of conduit 6 to under cover clip protector 5d. Cover clip protectors 5b, cover clip through protector 5e and cover clip protector 5d are installed on a main embodiment 1a which is installed on a support 15c where bolt hardware 16 can pass through attachment area 9 into the support 15c. FIG. 30 gives a detail to one form of completed installation of cover clip protector 5b and cover clip protector 5d using pipe 25 installed over a main embodiment 1a as the protection medium for a conduit 6 which is installed inside the main embodiment 1a on a block type of support 15c. Signage 26 is now shown attached to a protection pipe 25 providing notification of the conduit type, style, contents or similar. FIG. 30 also provides in the completed installation a way to secure main embodiments 1a and block type of support 15c together providing additional protection to conduit 6 components.

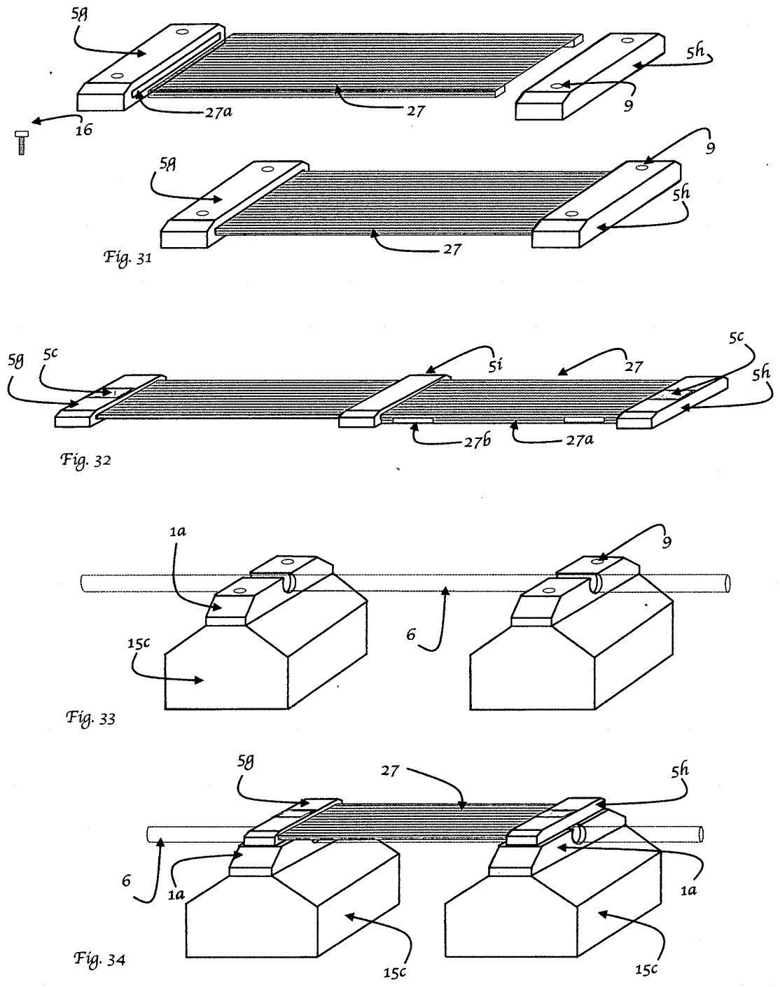

FIG. 31 through FIG. 34 now illustrate another means of conduit protection where in FIG. 31 a protection platform 27 is shown ready to install into platform cover clip protector 5g and platform cover clip protector 5h by way of the installation slot 27a. Attachment areas 9 are shown where Bolt hardware 16 can be inserted. FIG. 32 provides an example of the use of platform cover clip protector center 5i which is installed between platform cover clip protector 5g and platform cover clip protector 5h where a light 5c is illustrated as an option. Platform 27 is illustrated now with an option of side protection 27a wherein platform 27 extends at a downward angle illustrated as perpendicular, but similar is possible. This now illustrated side protection 27a area may include marking or labelling means for identification of the conduit and or the conduits contents or the conduits use. Vent air flow areas or inspection areas 27b may be provided. FIG. 33 is shown with a conduit 6 installed within a main embodiment 1a to where the main embodiment 1a is installed on a block type of support 15c without a protection method. Attachment area 9 is formed as part thereof the main embodiment 1a or marked “attachment point” is illustrated to show where attachment points are possible to a block type of support 15c. FIG. 34 is shown as a representation of what a completed installation of this means of protection could look like. A protection platform 27 is shown installed between platform cover clip protector 5g and platform cover clip protector 5h to where protection is now provided to a conduit 6 which is installed in a main embodiment 1a attached to a block type of support 15c. FIG. 34 also provides in the completed installation a way to secure single block type supports 15c together providing additional protection to conduit 6 components.

FIG. 35 through FIG. 37 illustrates a protection method similar to that shown in FIG. 31 through FIG. 34 with noticeable changes. Further to those protection methods previously illustrated FIG. 35 now illustrates an elongated device described as an under support 27a which can be used as a means to provide protection from the underside of conduit 6. The under support 27a also functions as a support for semi ridged conduits 6 wherein this elongated channel under support 27a may be attached to and between main embodiments 1ka and 1kb providing underlying support and protection for entire lengths of semi ridged conduits 6. Under support 27a can also be marked and labeled on the underside for conduit 6 identification. Further to under support 27 FIG. 35 now illustrates, a lower top section or lower plateau 11b with raised ends or a higher plateau 11c, this is formed in the main embodiment 1ka or 1kb to allow for the protection platform 27 or the cover plate 5a to be set or to rest within the main embodiment 1ka or 1kb. The lower plateau 11b may have a lower plateau notch 11f in which accommodation can be made for thicker structural member 11g if provided within a protection platform 27. This is now shown and may replicate within any embodiment as described or shown in drawings or figures of this DETAILED DESCRIPTION. FIG. 35 continues with description of the cover plate 5a where an attachment area 9 may be provided to aid in the attachment of bolt hardware 16. The cover plate 5a may have a light 5c for visual indication or identification if so desired. The protection platform 27 may have attachment areas 16a provided as part of the platform, the attachment area 16a holes may be recessed to allow for flush mounting for the bolt hardware 16 if made of material that is solid; however, if expanded type metals or other materials are chosen or used the bolt hardware 16 would be chosen for each material type used. Attachment areas 9b can be provided to match or line up with the attachment areas 9b of the cover plate 5a and the attachment areas 16a of the protection platform 27, or notification can be given to the particular area where bolt hardware 16 is to be attached to remove mistakes made by the installer where damages could occur to the conduit 6. FIG. 36 now shows a conduit 6 supported in a main embodiment 1k with physical protection of the conduit 6 by means of the protection platform 27 which is shown attached to the main embodiment 1k with bolt hardware 16b. The above description is shown to provide details of conduit 6 protection and as seen in FIG. 36 the flat top provides physical protection while providing a flat work surface where conduits 6 might be installed where workers might happen to stand or walk on the protection platform 27. Centerline cl illustrates physical side impact protection wherein any main embodiment or now illustrated as main embodiment 1k has material substance or a clear physical distance separation from the conduit 6. FIG. 37 shows another method of attachment of a cover plate 5a which is shown at cover plate 5w wherein the cover plate 5w is without a light 5c of FIG. 35 allowing for a lower profile. This lower profile can also be accomplished and installed level with the protection platform 27 when the cover plate 5a is manufactured to accept a protection platform 27 that is formed to fit a lower inside of the lower plateau 11b of FIG. 35. FIG. 37 also provides in the completed installation a way to secure main embodiments 1a together providing additional protection to conduit 6 components. Signage 26 is shown where additional labelling or marking can be provided or incorporated as part of side protection 27c where signage is shown at 26a. Flagging 26c is also possible where attachment is possible when fitted into the main embodiment.

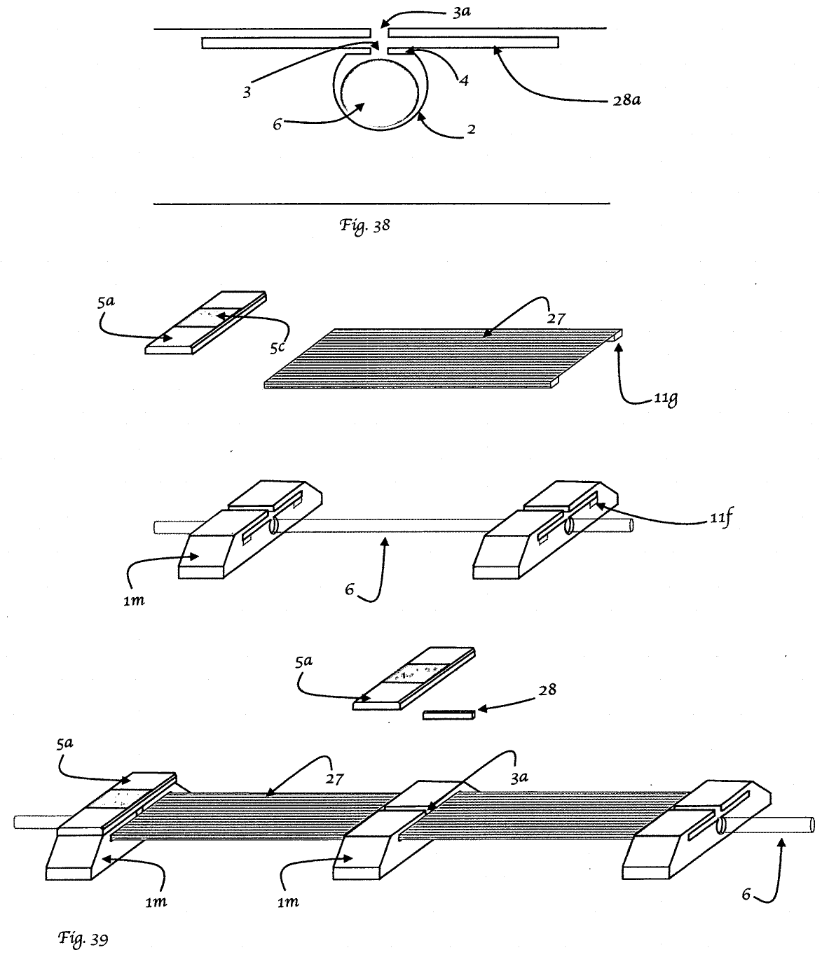

FIG. 38 illustrates a conduit 6 being supported within a conduit cradle 2 where now a protection insert opening 28a is illustrated with representation of where a protection platform 27 could be inserted. The protection insert opening 28a is between insert opening 3 and upper insert opening 3a Overlaying material 4 will not be affected by this now newly formed protection insert opening 28a.

FIG. 39 illustrates protection as formed in part or in whole of the invention or a main embodiment where cover plate 5a is illustrated having a light 5c. Cover plate 5a may be used to cover the main embodiment 1m providing protection for conduit 6 or in conjunction with the protection platform 27 which provides conduit 6 protection outside of the main embodiment 1m as well the conduit 6 within the main embodiment 1m. The protection platform may have supporting structural members 11g which fit into lower plateau notch 11f of the main embodiment 1m. After placement or fitting of protection platform 27a filler cap 28 could be inserted into upper insert opening 3a of the main embodiment 1m.

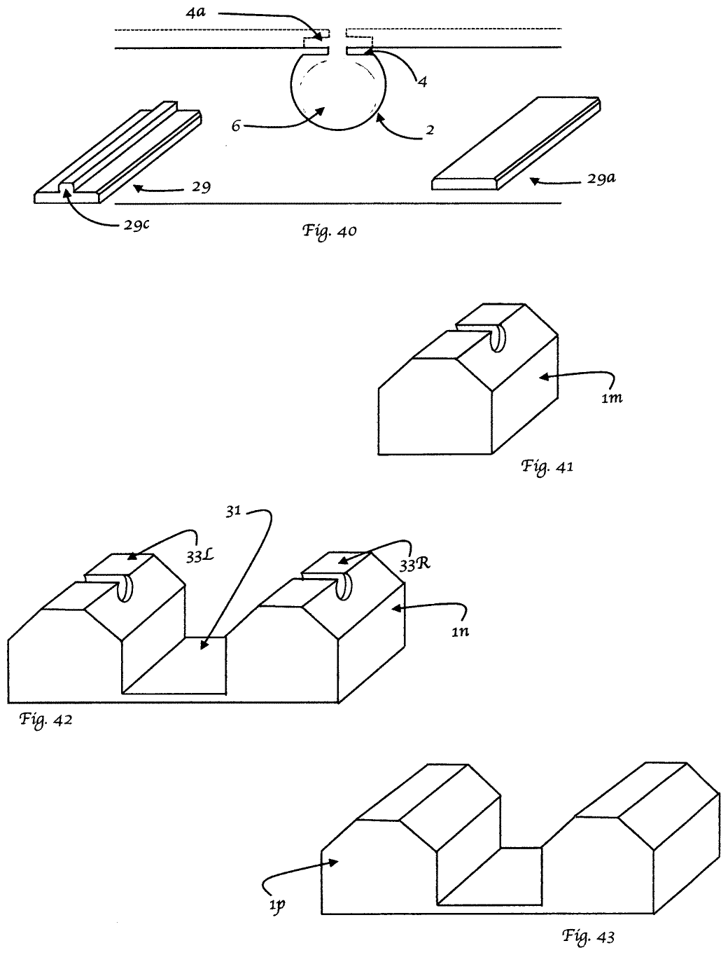

FIG. 40 illustrates a conduit 6 being supported within a conduit cradle 2 where the top section above the conduit can be fitted with a slide cover 29 which has an elongated upper ridge 29c or a flat top side cover 29a without the elongated upper ridge 29c. These covers as described can be fitted or slid into slide clip 4a opening also illustrated in FIG. 2 where use is possible in any of the mentioned main embodiments throughout. Attachment will not affect overlaying material 4 when used.

FIG. 41 is a main embodiment 1m or “Single Block” in where a conduit can be inserted into the main embodiment 1m as described previous within this disclosure including descriptions given in FIG. 1 and FIG. 1a.

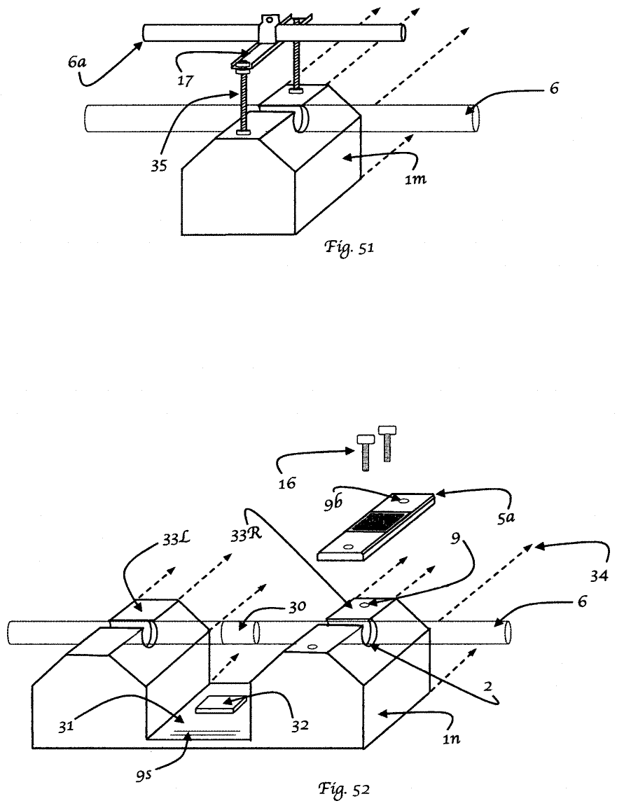

FIG. 42 is described as a main embodiment 1n or “Insert Double Block” in where a conduit can be inserted into the main embodiment 1m as previous descriptions disclosed within this writing in particularly in FIG. 1 and FIG. 1a. FIG. 42 illustrates a lowered elevation within one support, device, or main embodiment described now as lower area 31 which is located between upper ridge 33R and upper ridge 33L; this lower elevation is intentional for the support of a conduit at two locations and for support or protection of a component attached to, or as part of a conduit such as a coupling, valve, union, flange, junction box, regulator, flow indicator or similar to these. This intentional lower area 31 now illustrated and described will be similar throughout the writing and the purpose is the same regardless of the main embodiments configuration, this includes the lower area 31 of FIG. 43 through FIG. 47 and others as reference or illustrated. The lower area 31 will provide a controlled area for the purpose of component protection by supporting a component on all sides or attachment points to a conduit regardless of the attachment means of the component to a conduit. The lower area 31 will in addition provide an area for component inspection which includes the attachment methods used to attach the component such as welds, threads, clamps or similar, a testing area, which can include all aspects of testing such as leak testing, pressure testing, non destructive testing, bolt torque testing or similar to these which can include opening and closing of unions, junction boxes, valves or similar to these. The center to center distance from upper ridge to upper ridge or the center of any upper ridge to the middle or center of the lower area 31 dependent upon the conduit circumference and the component attached to the conduit. The lower area 31 will provide in addition to the above noted remarks as an option, lighting, lighting components, drainage areas or structural attachment points which may also include expansion and contraction provisions as described in FIG. 52.

FIG. 43 can now be described similar to FIG. 42 except now this main embodiment 1p or “Double Block” does not cradle a conduit within the main embodiment 1p; this “Double Block” is without conduit cradles 2 and insert opening 3 as illustrated and described in FIGS. 1 and 1a. This main embodiment provides without conduit insertion within one embodiment support for a conduit which can be supported at two locations while providing an open area for a component between the two conduit supporting areas within the same main embodiment 1p.

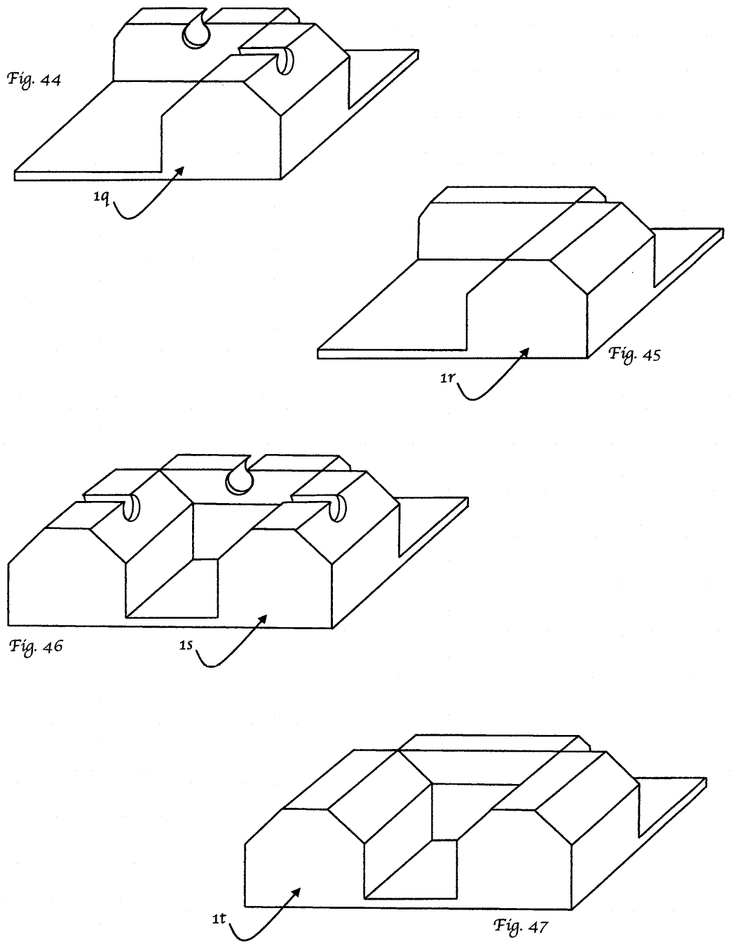

FIG. 44 can now be described as a main embodiment 1q or “Insert 90 Block” in where a conduit can be inserted into the main embodiment 1q as described previous including FIG. 1 and FIG. 1a at two locations perpendicular to the first while providing an open area for a component between the two conduit supporting areas within the same main embodiment 1q.

FIG. 45 can now be described similar to FIG. 44 except now this main embodiment 1r or “90 Block” does not cradle a conduit within the main embodiment 1r; this “90 Block” is without conduit cradles 2 and insert opening 3 as illustrated and described in FIG. 1 and 1a. FIG. 45 can now be further described with illustration of the main embodiment 1r or “90 Block” in where a conduit can be supported at two locations perpendicular to the first while providing an open area for a component between the two conduit supporting areas within the same main embodiment 1r.

FIG. 46 can now be described with illustration of a main embodiment 1s or “Insert T Block” in where a conduit can be inserted into the main embodiment 1s as described previous including FIG. 1 and FIG. 1a at three locations while providing an open area for a component between the three conduit supporting areas within the same main embodiment 1s.

FIG. 47 can now be described similar to FIG. 46 except now this main embodiment 1t or “T Block” does not cradle a conduit within the main embodiment it; this “T Block” is without conduit cradles 2 and insert opening 3 as illustrated and described in FIG. 1 and 1a. FIG. 47 can now be further described with illustration of a main embodiment 1t or “T Block” in where a conduit can be supported at three locations while providing an open area for a component between the three conduit supporting areas within the same main embodiment it.

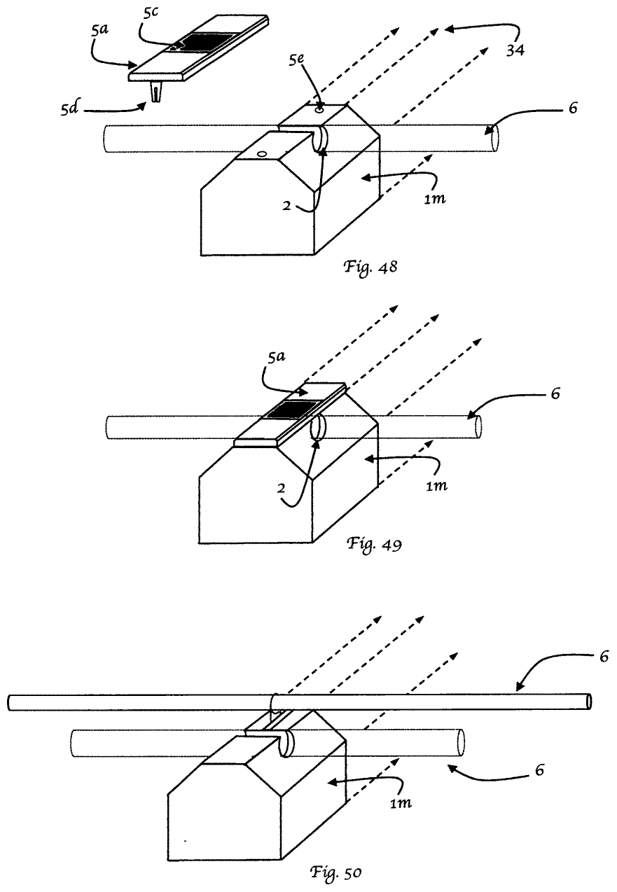

FIG. 48 is an illustration of a cover plate 5a and a main embodiment 1m where the cover plate 5a can be attached to the main embodiment 1m by the use of push pins 5d which are inserted into the push holes 5e located on the top of the main embodiment 1m above the conduit 6. The conduit 6 is illustrated supported by the conduit cradle 2 which is in the main embodiment 1m. Dashed line segments 34 with arrow ends are included within the illustration to show a continuation of the support including all attributes of a main embodiment now and throughout the following or previous descriptions or illustrations where sense can be made. For longer models where repetitions are created break away cuts may be formed within a main embodiment for ease of separation and means to keep known distance separations constant. The cover plate 5a is illustrated with a light 5c incorporated as part of the cover plate 5a as described previous. Conduit 6 attachment to main embodiment 1m is as described in the Summary and Descriptions of FIG. 1 and FIG. 1a or where similar descriptions are made.

FIG. 49 is described as a main embodiment 1m in continuation of FIG. 48 to where now the cover plate 5a is attached to the main embodiment 1m above conduit 6 which is supported within the main embodiment 1m by the conduit cradle 2 located under the cover plate 5a. It is noticeable now the cover plate 5a provides protection above the conduit 6 where below and side protection is provided by the main embodiment 1m.

FIG. 50 is illustrated to provide description for the use of other hanger methods which could be attached to a main embodiment 1m. Parallel conduits 6 are illustrated to represent support methods where code, engineering or expansion of equipment or conduits 6 require such attachment. This system of attachment is possible to any aspect or position of the main embodiment 1m or other main embodiments where sense can be made including directly over top of another conduit 6 supported within or by the main embodiment 1m as later described within other figures.

FIG. 51 is illustrated to provide description for the use u-channel strut 17 supporting a conduit 6a above a conduit 6 which is installed in the main embodiment 1m. The vertical distance may be decided depending on the length of threaded rod 35 used to elevate the u-channel strut 17. Conduit 6 and conduit 6a separation by vertical distance in this manner or separation of conduits in general as illustrated throughout the drawings or illustrations in this disclosure provide improved methods for distance separation where heat gains or losses are possible when conduits are installed in close proximity to one and other or where distance separation could be enforced by the inspection body or authority having jurisdiction.

FIG. 52 describes a main embodiment 1n or “Insert Double Block” which illustrates means of conduit 6 support at two locations upper ridge 33L, upper ridge 33R and where a component 30 is supported between the upper ridges on or within one support, device or main embodiment. This can be described now as main embodiment 1n which has two raised ridges at either side of a lower area 31. The elevation change or lower area 31 within the main embodiment 1n is intentional providing an area for inspection, testing or similar for components 30 within a conduit 6 while providing fundamental support on both sides of a component 30 at both ends of the conduit 6. Attachment of the conduit 6 can be made to the main embodiment 1n for securing a conduit 6 which is placed inside the conduit cradles 2; critical areas are supported with equal respect providing in one conduit a support means to provide support at two locations of a conduit 6 while providing critical component support adding strength to the entire system. The lower area 31 may also provide a means for structural fixed attachment points 9s which may be incorporated at strategic places within the lower area 31 including the opposite side of those illustrated. The attachment points 9s may include a built in means for expansion and contraction engineering when so desired or required by code or hazard analysis. The fixed attachment points 9s built within the lower area 31 in one aspect can be accomplished by providing elongated slots extending from one side to the other side where the length of the fixed attachment points 9s is determined by the coefficient of expansion for the particular need. Conventional attachment means such as screws, washers, glues, threaded rod, nuts and bolts or similar can be used as required for attachment through the attachment points 9s. The lower area 31 attachment points 9s may also function as drainage areas for water, condensate or similar. The lower area may be solid in formation however ribs or bosses may be added for strength or incorporated within to lessen the overall thickness. The thickness with additions of ribs or bosses throughout the lower area 31 or main embodiment 1n is possible to allow for a support of lighter overall weight if so desired without compromising the strength, durability, footprint for load distribution, drainage, vibration dampening, securing or other aspects of the invention. The lower area 31 may also provide an area for attachment of lighting and lighting components such as solar panels, batteries, and a light wherein description for all is given as lighted area 32. For areas in need of inspection or visibility during times of impaired visibility this lighted area 32 may be provided, this lighted area 32 also functions to display areas of notability such as maintenance tasks involving component manipulation or similar is required and or areas to where safe work practices must be maintained to avoid trips, falls or other hazards. Lighted area 32 may provide illumination by use of stored energy which can include solar lighting provided as an attachment to or be fixed within the main embodiment 1n wherever so desired including mounting of lighting on upper ridges or vertical sides or slopes. No discrimination is given to the design for the numbers of repetitions of conduit 6 attachments or other descriptions, this is shown in dotted extension 34 as a continuation of the above noted remarks in a mirror like fashion. Further description can be described as given in FIG. 1 and FIG. 1a for means of conduit 6 insertion into the main embodiment 1n including but not limited to cover attachments, protection attachments, marking and similar aspects as sense allows in those descriptions as provided. Attachment of protection methods are possible as described through FIGS. 27 through 39. Cover attachment as illustrated in this figure are described as or with the use of a cover plate 5a which has or may have per-determined attachment areas 9b or knockouts through which bolt hardware 16 can be inserted through the cover plate 5a into attachment areas 9 of the main embodiment 1n. The attachment areas at the main embodiment 1n may be pre-drilled, marked or indicated for its use or simply left to the installer to determine the location as not all main embodiments 1n require a cover as shown at upper ridge 33L which is intentionally without a cover.

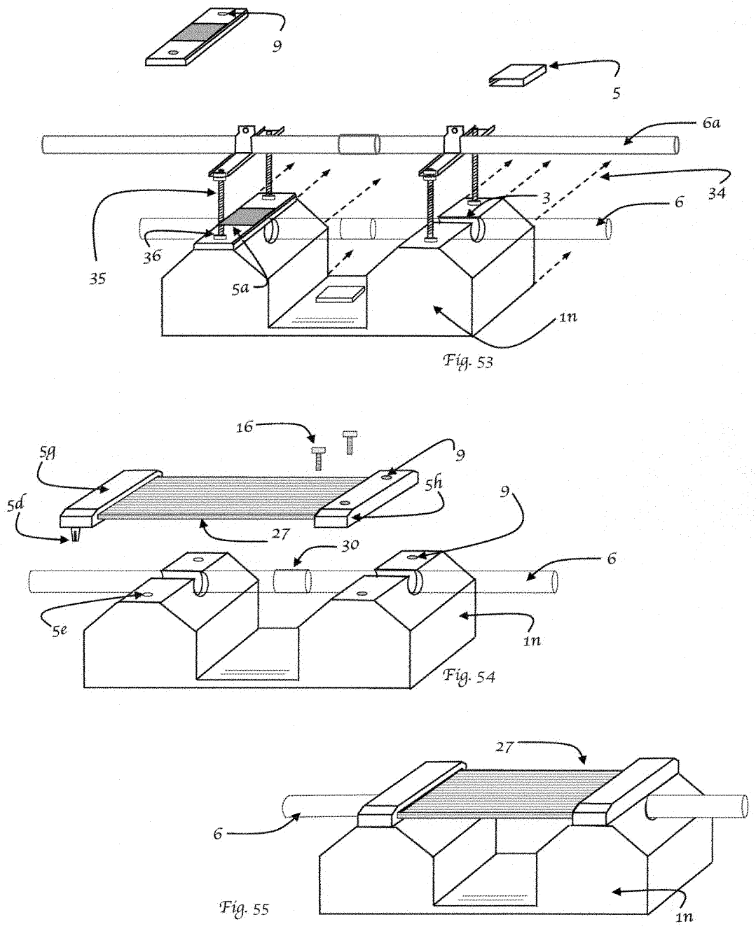

FIG. 53 is a main embodiment 1n or “Insert Double Block” where conduit 6a stacking is illustrated using threaded rod 35 to elevate an additional conduit 6a above conduit 6 which is supported within the main embodiment 1n. This allowance is made for space saving as well as when conduit 6 separation is required by designs such as gas conduit 6 separation from electrical conduits 6a. Threaded rod 35 or similar may be used for the elevation change which can be attached to the main embodiment 1n with the use of nuts and washers 36. The nuts and washers 36 are additionally used to secure a cover plate 5a where the threaded rod 35 may pass through the cover plate 5a at attachment area 9. Alternative covers are possible as illustrated with the use of cover clip 5 which simply clips over the insert opening 3. The physical separation for conduits 6 and conduit 6a may also be achieved within one embodiment without the elevation change if so desired with a replication of the main embodiment 1n illustrated as dotted extension 34 as a continuation of the above noted remarks in a mirror like fashion. This allowance for the above noted may be used with some or all of the previous and later described main embodiments as determined by code and hazard assessments.

FIG. 54 is described with illustration of a main embodiment 1n having protection provided by a protection platform 27 with the use of cover clip protector 5h and cover clip protector 5g. The assembly of the protection platform 27 with cover clip protector 5h and cover clip protector 5g is installed directly on the top surface of the main embodiment 1n over the conduit 6 at either push holes 5e or alternatively attachment areas 9. The push holes 5e or attachment areas 9 may be sized in the same manner to accept either push pins 5d or bolt hardware 16. If the method of attachment is with use of bolt hardware 16 the cover clip protector 5h may have openings or attachment area 9 for the bolt hardware 16 to pass through the cover clip protector 5h into the main embodiment 1n or if the cover clip protector as shown on cover clip protector 5g has push pins 5d then attachment to the main embodiment 1n is simply completed by pushing the cover clip protectors 5g push pins 5d into the push holes 5e of the main embodiment 1n.

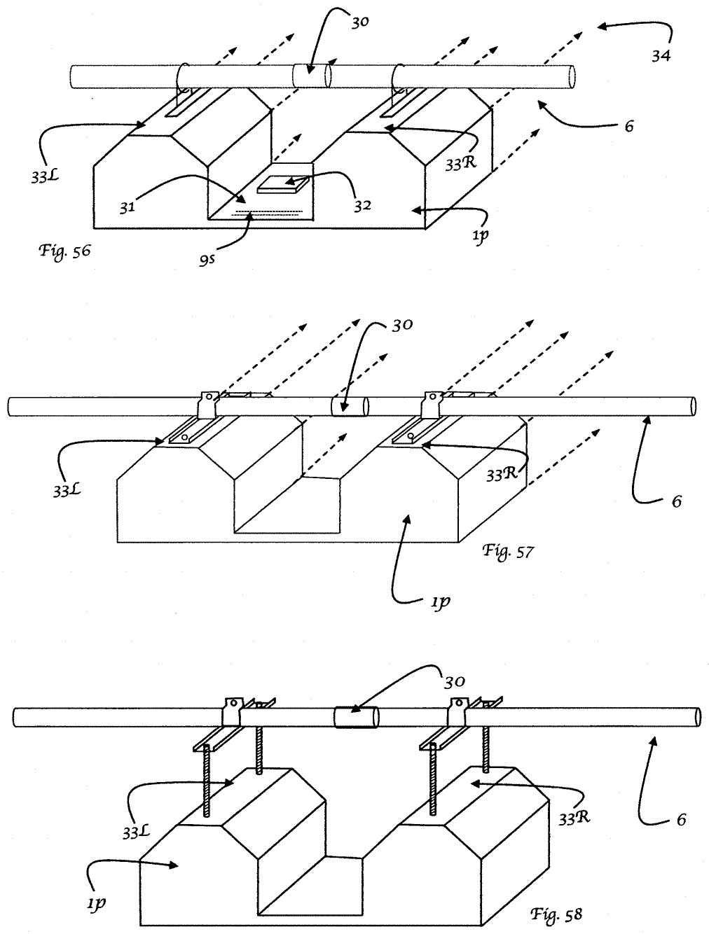

FIG. 55 is the completed movement of FIG. 54 which is described now as “Insert Double Block” having complete protection for a conduit 6 with the addition of the protection platform 27 on the main embodiment 1n above the conduit 6. The conduit 6 is now protected from physical damages that might be occurred while allowing the conduit 6 expansion and contraction flexibilities within the main embodiment 1n.

FIG. 56 described now wherein a main embodiment 1p or “Double Block” illustrates means of conduit 6 support at two locations upper ridge 33L, upper ridge 33R providing component 30 support. The main embodiment 1p can be described as a support which has two raised ridges at either side of a lower area 31. The elevation change or lower area 31 within the main embodiment 1p is intentional providing an area for inspection, testing or similar for components 30 within a conduit 6 while providing fundamental support on both sides of a component 30 at both attachment ends of the conduit 6. This now described main embodiment 1p is similar to that of the “Insert Double Block” of FIG. 52 with the noticeable, now not included, insert opening 3 or conduit cradle 2 which is intentional to this design. The conduit of this main embodiment 1p is to be supported on the top of upper ridge 33L and upper ridge 33R with conventional hangers or similar while continuing to also provide support at both sides of a component 30. The support continues to have attributes such as lighted area 32, attachment points 9s and lower area 31 as described in previous descriptions of the same. This as with other illustrations and descriptions is illustrated with the use of dotted extension 34 illustrating a continuation of the main embodiment and its features.

FIGS. 57 and 58 are illustrated and described to illustrate other forms of support of a conduit 6 on the upper ridge 33L and upper ridge 33R for main embodiment 1p; whatever the attachment means to this main embodiment the design of the support is as described previous where component 30 is supported and protected including two points of contact on one main embodiment 1p for a conduit 6.

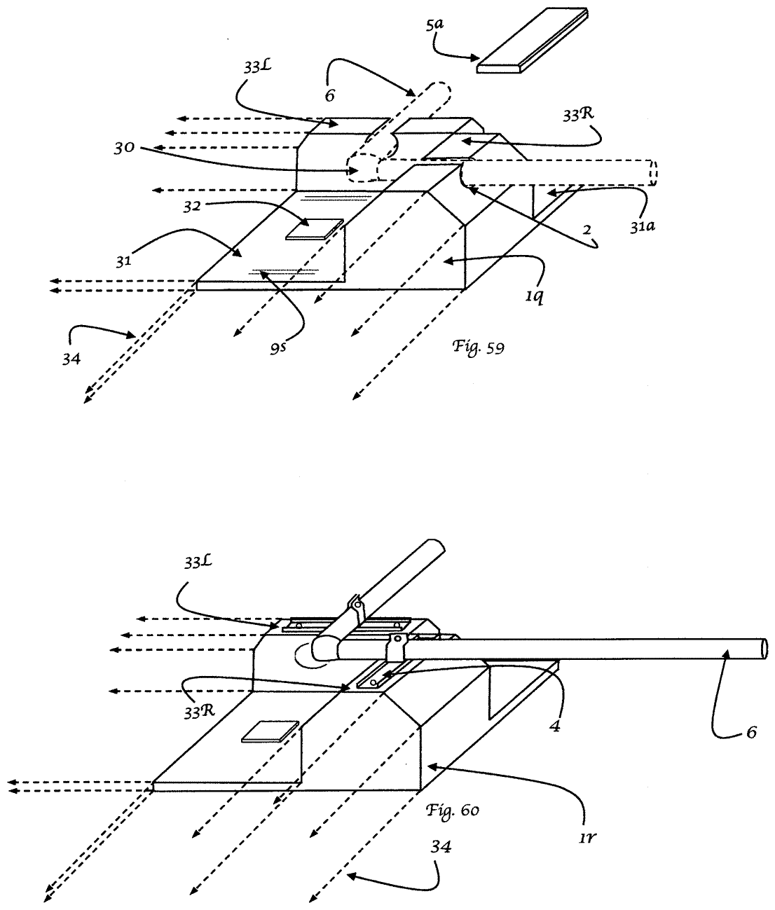

FIG. 59 is described now with illustration wherein a main embodiment 1q or “Insert 90 Block” illustrates means of conduit 6 support in which support is provided to directional change of conduits 6 including support of the components 30. The main embodiment 1q can be described as a support with two raised portions upper ridge 33L and upper ridge 33R perpendicular to one and another with one or more lower areas described as lower area 31 and lower area 31a. The lower areas are intentional providing an area for inspection and testing or similar for components 30 within a conduit 6 while providing fundamental support on both sides of a component 6 where attachments can be made to the main embodiment 1q for securing a conduit 6 into a conduit cradle 2; critical areas are supported with equal respect providing in one conduit support a means to provide support at two locations while providing component protection adding strength to the entire system in this embodiment that provides support at directional changes. The lower area 31 or lower area 31a may also provide a means for structural fixed attachment points 9s which may be incorporated at strategic places including opposite of those illustrated on lower area 31 including lower area 31a which may also include built in expansion and contraction engineering for both lower areas when so desired or required by code or hazard analysis. Lower area 31a as illustrated could be omitted in some cases. The fixed attachment points 9s may be built within the lower area 31 and or lower area 31a, this can be accomplished by providing elongated slots extending from one side to the other side where the length of the fixed attachment points 9s are determined by the coefficient of expansion for the particular need. Conventional attachment means such as screws, washers, glues, threaded rod, nuts and bolts or similar can be used as required for attachment through the attachment points 9s. The lower area 31 and lower area 31a attachment points 9s may also function as drainage areas for water, condensate or similar. The lower areas may be solid in formation, however, ribs or bosses may be added for strength or incorporated within to lessen the overall thickness. The thickness with additions of ribs or bosses throughout the lower area 31, lower area 31a, or main embodiment 1q is possible to allow for a support of lighter overall weight if so desired without compromising the strength, durability, footprint for load distribution, drainage, vibration dampening, securing or other aspects of the invention. The lower area 31 and lower area 31a can be described in the same as described for lower area 31 of FIG. 52 for lighted area 32 and attachment points 9s. No discrimination is given to the design for the numbers of repetitions of conduit 6 attachments or other descriptions, this is illustrated in dotted extension 34 as a continuation of the above noted remarks in a mirror like fashion. Raised portions, upper ridge 33L and upper ridge 33R may incorporate other conduit support means above the conduit 6 which is inserted into the conduit cradle 2 as described elsewhere within this writing. Cover plate 5a is illustrated above the main embodiment 1q; however, to have upper ridge 33R unobstructed in the illustration the cover plate 5a of the illustration is not attached to the main embodiment 1q and direction is given now that attachment is possible in the same manner as previous descriptions provided for such attachment.

FIG. 60 is a main embodiment 1r or “90 Block” illustrating means of conduit 6 support in which support is provided to directional change of conduits 6 including the protection of components 30. The main embodiment 1r is similar to that of the “Insert 90 Block” of FIG. 59 with the noticeable, now not included, insert opening 3 or conduit cradle 2 which is intentional to this design. The conduit 6 is now shown supported on the top of upper ridge 33L and upper ridge 33R with conventional hangers or similar and as illustrated now with u-channel strut 17 while continuing to also provide support at both sides of a component 30. The support continues to have attributes such as lighted area 32, attachment points 9s, lower area 31 and lower area 31a as described previous including those descriptions in FIG. 59. Attachment points 9s when included function and perform the same as those in previous description including dotted extension 34 as a continuation of the above noted remarks in a mirror like fashion.

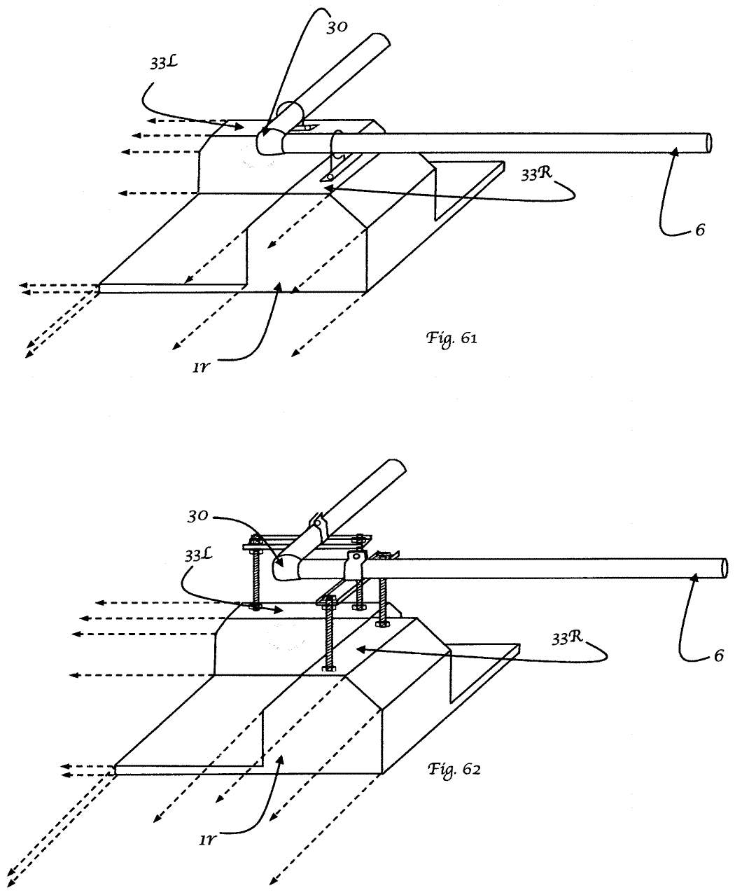

FIG. 61 and FIG. 62 are illustrated and described to illustrate other forms of support of a conduit 6 on the upper ridge 33L and upper ridge 33R for main embodiments 1r; whatever the attachment means, main embodiment 1r provides the same protection and support as described previous where component 30 is supported including two points of contact on one main embodiment 1r for a conduit 6.

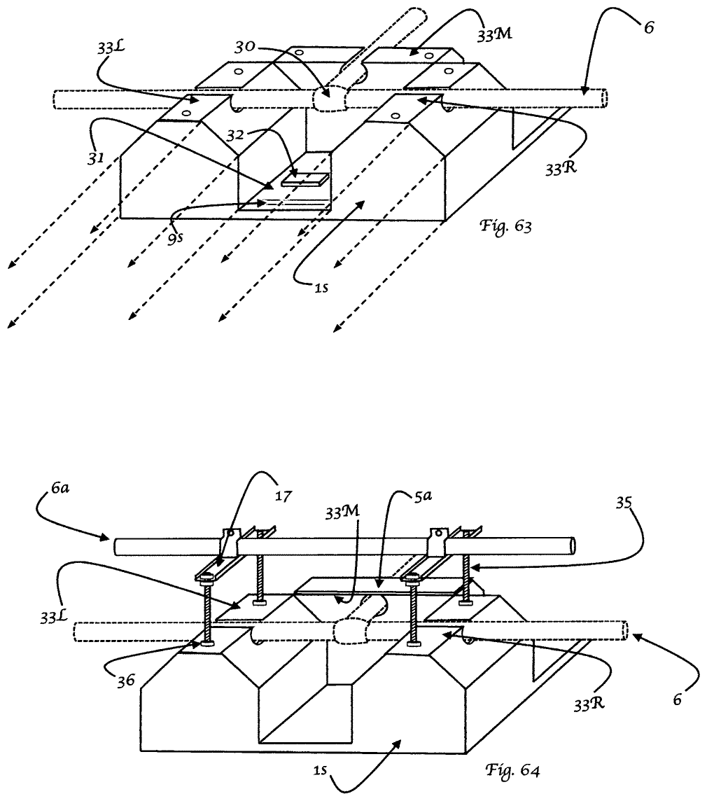

FIG. 63 is described as a main embodiment 1s or “Insert T Block” which illustrates means of conduit 6 support in three locations upper ridge 33R, upper ridge 33L and upper ridge 33M where a change of direction of a conduit 6 extends outward at a 90-degree angle or branch line forming a tee intersection where conduit 6 continues in a same directional path as the original directional path from upper ridge 33R to upper ridge 33L. The main embodiment 1s is now described illustrating an elevation change or lower area 31, lower area 31a and lower area 31b illustrated in FIG. 71. The lower areas are intentional providing an area for inspection, testing, lighting, or similar to those listed for components 30 within a conduit 6 system as described previous including descriptions in FIG. 42 for lower area 31. Upper ridge 33R, upper ridge 33L and upper ridge 33M provide fundamental support on three sides of a component 6 where attachments can be made to the main embodiment 1s for securing a conduit 6; critical areas are supported with equal respect providing in one main embodiment 1s a means to provide support at three locations while providing complete component protection adding strength to the entire system. The lower area 31 of this figure and lower areas 31a and 31b illustrated in FIG. 71 now described create three lower areas which may when required also provide a means for structural fixed attachment points 9s which may be incorporated at strategic places including opposite of those illustrated on lower area 31 including diagonal lower areas which may also include built in expansion and contraction engineering for all lower areas when so desired or required by code or hazard analysis. Diagonal lower areas to lower area 31 could be omitted in some cases or made angular. The fixed attachment points 9s may be built within the lower areas 31, and 31a and 31b illustrated in FIG. 71, this can be accomplished by providing elongated slots extending from one side to the other side where the length of the fixed attachment points 9s are determined by the coefficient of expansion for the particular need. Attachment means such as screws, washers, glues, threaded rod, nuts and bolts or similar can be used as required for attachment through the attachment points 9s. The lower areas 31 and 31a and 31b as described in FIG. 71 including lower areas attachment points 9s may also function as drainage areas for water, condensate or similar. The lower areas may be solid in formation, however, ribs or bosses may be added for strength or incorporated within to lessen the overall thickness. The thickness with additions of ribs or bosses throughout the lower areas including the upper ridge 33R, upper ridge 33L and upper ridge 33M is possible to allow for a main embodiment 1s of lighter overall weight if so desired without compromising the strength, durability, footprint for load distribution, drainage, vibration dampening, securing or other aspects of the main embodiment 1s. The lower area 31 may also provide an area for attachment of lighting and lighting components such as solar panels, batteries, and a light wherein description for all is given as lighted area 32. For areas in need of inspection or visibility during times of impaired visibility this lighted area 32 may be provided, this lighted area 32 also functions to display areas of notability such as maintenance tasks involving component manipulation or similar is required and or areas to where safe work practices must be maintained to avoid trips, falls or other hazards. Lighted area 32 may provide illumination by use of stored energy which can include solar lighting provided as an attachment to or be fixed within the main embodiment 1n wherever so desired including mounting of lighting on upper ridges or vertical sides or slopes or other lower areas of this main embodiment 1s. FIG. 63 is now described further to illustrate the conduit 6 attachment to main embodiment 1s by the same description given previous including FIGS. 1 and 1a. The main embodiment 1s or “Insert T Block” as illustrated is represented showing a flat top with sloping sides which progress downward to the base with straight lines, this illustration is a basic shape and is to be described as a general design. Regardless of the shape a critical aspect is the main embodiment 1s upper ridges on all connecting points of a component 30. In some aspects of the inventive features other shaped main embodiments 1s are included within the design which perform the same support on all sides of a component 30. The main embodiment 1s or “Insert T Block” may in some models be square shaped, rectangular shaped, or of a shape that allows component 30 support with the above noted features and allowance is made for lower areas to be angular shaped or similar.

FIG. 64 is described similar to that of FIG. 63 in that the main embodiment 1s provides component protection while supporting a conduit system at three locations. FIG. 64 is with the addition of conduit 6a which is elevated above conduit 6 with the use of u-channel strut 17, threaded rod 35 where attachment to the main embodiment 1s at upper ridges 33R and 33L is with the use of nuts and washers 36. Cover plate 5a is installed on upper ridge 33M.

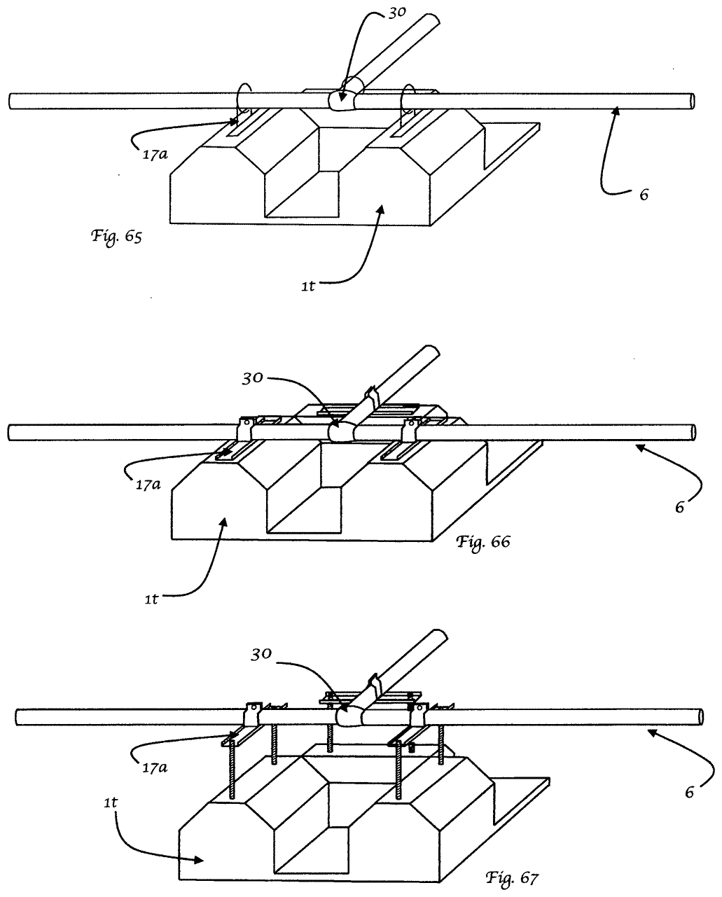

FIG. 65 describes a main embodiment 1t or “T Block” which illustrates means of conduit 6 support in where a change of direction is possible while supporting the conduit in a same directional path as the original, thus providing support for the conduit 6 at three positions while protecting a component 30. The main embodiment it can be described as a support with three raised sections or upper ridges as illustrated in FIG. 71 and described in previous including the description of FIG. 63 for the upper ridges and with one or more lower portions or lower area 31 and lower areas 31a and 31b illustrated in FIG. 71 also described previous including the description given in FIG. 63. The main embodiment 1t in all respects can be described the same as FIG. 63 except that now illustrated with the intentional omission of the insert opening 3 and conduit cradle 2. This omission of insert opening 3 and conduit cradle 2 is done purposefully to form a main embodiment for conduit 6 attachment on the top of the upper ridges wherein a conduit is not supported within a conduit cradle and now illustrated using hanger hardware 17a.

FIG. 66 and FIG. 67 are described and illustrated to show other methods of hanger hardware 17a and attachment for conduits 6 to the main embodiment 1t where a component 30 is between three conduit 6 attachment points.

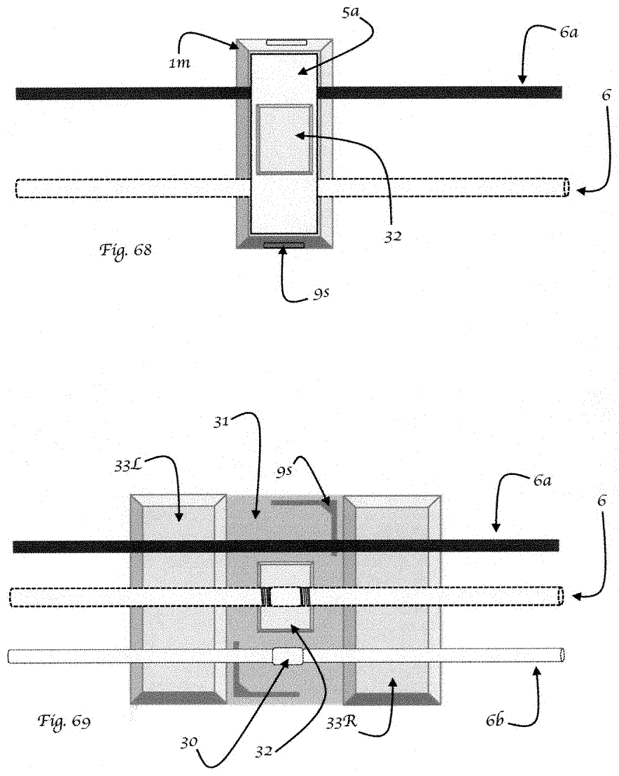

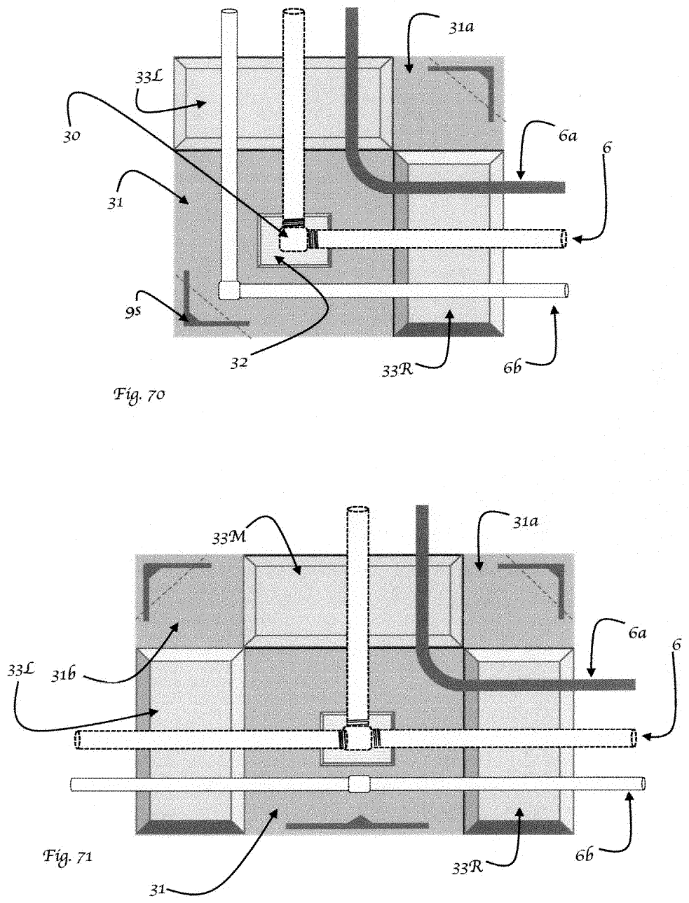

FIG. 68 through FIG. 71 are now described and illustrated in plan view to show main embodiments “Insert Single Block”, “Insert Double Block”, “Double Block”, “Insert 90 Block”, “90 Block” “Insert T Block” or “T Block”. These are general examples only; however, one can see the function and importance through these examples of how the components 30 are supported in close proximities to conduits 6, 6a or 6b attachment points to or within upper ridge 33R or upper ridge 33L or upper ridge 33M provided within one main embodiment. These illustrations are general and illustrations as such are described generally as to not limit the intentions of the inventive features as described within this disclosure. However, a plan view of the main embodiments could provide another view of the use of the main embodiments. The conduits within this description for the purpose of illustration are named as; Conduit 6 is a threaded type where the attachment to the component 30 is screwed. Conduit 6b is a socket weld type where the attachment to the component 30 is welded. Conduit 6a is a wire. These FIG. 68 through FIG. 71 may all have a lighted area 32 near or under a component 30 in the lower area 31 with the exception of the singular main embodiment of FIG. 68 in which a light 5c is illustrated as part of a cover plate 5a which is installed over the conduit 6 or 6a. The attachment points 9s are shown through the illustrations mainly in the lower areas however with a singular support these attachment points 9s are on the sides of a main embodiment. Lower areas 31a and lower area 31b may be optional or angular cut or similar. Critical component support is now seen; by providing multiple points of contact for a conduit in close proximity to a component 30 it is evident that not only the conduits are supported better but now the components as well can be protected from damages which could occur.

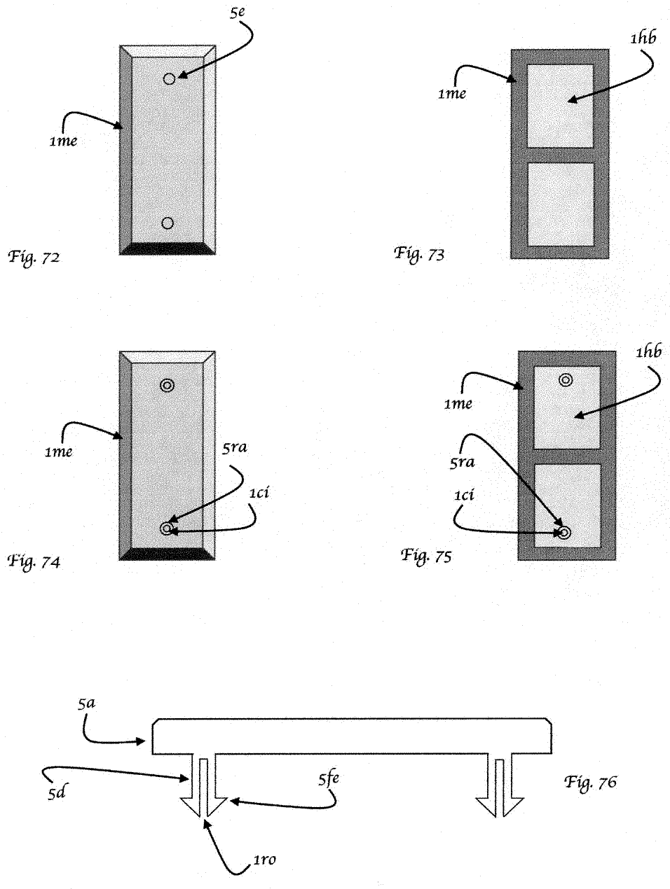

FIG. 72 described and illustrate the top single support or any upper ridge 33L, 33R, 33M or higher plateau 11c of FIG. 1a. This main embodiment 1me of this figure is illustrated to show an example in plan view for a push hole 5e which is a dedicated intentional area within a main embodiment 1me for the attachment of push pins 5d of FIG. 1b or similar throughout this disclosure.

FIG. 73 is described with illustration of the bottom of a single support or any upper ridge 33L, 33R, 33M or higher plateau 11c of FIG. 1a. The bottom of main embodiment 1me may be solid or as illustrated now formed with a hollow area 1hb where description is given with illustration that push holes 5e of FIG. 72 intentionally do not extend entirely though the main embodiment 1me, this option is provided to allow for conduit and cover ejection or release when required due to extreme pressure which could occur by structural fatigue or similar. The push pins 5d as described throughout this disclosure are fitted by friction or pressure into the push holes 5e also described throughout this disclosure do not grip to the underside of a support or upper ridge however small drainage holes inside the bottom of the push holes 5e may be present and extend completely through the main embodiment 1me.

FIG. 74 described and illustrate the top of any single support or upper ridge 33L, 33R, 33M within this disclosure or higher plateau 11c of FIG. 1a. This figure illustrates a recessed area 5ra which may be used to fit a nut or washer or combination of these or similar hardware into the upper ridge topside allowing the completed action of tightening to be flush with the topside of an upper ridge. This recessed area 5ra may have the center inner portion 1ci removed or void not formed as part of the main embodiment 1me to allow passage of threaded rod 35 or similar of FIG. 53 though the main embodiment 1me to the underside of an upper ridge.

FIG. 75 is a description of the bottom of a single support or any upper ridge 33L, 33R, 33M or higher plateau 11c of FIG. 1a. It can be noticed with illustration and description now that the center inner portion 1ci passes or extends completely though to main embodiment 1me. Now on the underside of the upper ridge another recessed area 5ra appears for the purpose of nut and washer placement as described in FIG. 74. This now described recessed area 5ra may also be molded to mimic the shape of a nut or bolt head or similar allowing a nut to be held in place without the use of tools for the purpose of installation. This recessed area 5ra may additionally serve as a grip area for push pins 5d; this can be accomplished when the push pins 5d are flared out at the bottom as illustrated in FIG. 76.

FIG. 76 is described now similar to the push pins 5d of FIG. 1a and FIG. 73 with noted or described differences where push pin 5d has flared ends 5fe which are inserted into or through center inner portion 1ci of FIG. 75. The push pins 5d deflect inward as the flared ends press against the walls of center inner portion 1ci compressing the push pin 5d and flared ends 5fe at relief opening 1ro. Once the action of insertion is complete and the flared ends 5fe reach the recessed area 5ra illustrated in FIG. 75 the compressed push pin 5d and flared ends 5fe resume there original shape as center inner portion 1ci wall pressure is removed. The flared ends now larger than the circumference of the center inner portion 1ci grip the underside of an upper ridge holding in place cover plate 5a. The distance of travel through a main embodiment for the push pin 5d or other attachment hardware is dependent upon the thickness of a main embodiment which may be less than the outer vertical distance from base to height as the inner areas of main embodiments may be made hollow or void of materials when so desired at the time of manufacturing as illustrated and described as hollow block 1hb of FIG. 73 and FIG. 75. This hollow block 1hb is not intended to defeat the functions of recessed area 5ra and allowance is made for recessed area 5ra no mater the thickness of the main embodiment.

I claim:

1. A support, device or main embodiment for use in supporting elongated cylindrical shaped conduit, pipe or similar composed of nonmetallic materials or similar which may be recycled that has allowances for the use of metallic materials which may be comprised of multiple elements in combination wherein a main embodiment provides support for a conduit(s) at one or more locations and provides a means or methods for attachment to other objects or structures; the main embodiment may;
a) have a top or top sections with overlaying materials which is separated by a void or conduit insert opening to where a conduit is supported within the main embodiment where the top overlaying material above the conduit support area may deflect inwards or be moved in an inward direction towards the area of conduit support to where after the action of inserting the conduit through the overlaying material and insert opening the overlaying material may return to its original position.
b) have a top or top sections without overlaying materials where the top of the main embodiment has openings or voided of material at specific locations extending into the main embodiment.
c) have a top or top sections that are continuous in which has no opening or voids where a conduit is placed on the main embodiment.
Where the support, device or main embodiment can provide support to one or more conduits and or of different sizes which are interchangeable and may be in any configuration; the top insert opening may be closed by covers which may be recessed within the main embodiment or attached on top of the main embodiment; the covers can form in whole or in part, physical conduit protection or may include the use of a light or reflective material; the device which may provide for or incorporate, in part or in whole, in one embodiment or attachment thereof;
a) Expansion and contraction means.
b) Corrosion protection.
c) Wear protection.
d) Dielectric and galvanic protection.
e) Physical protection.
f) Identification means.
g) Hydraulic shock and Seismic shock protection.
h) Sound and temperature isolation.
i) Structural movement compensation.
j) Measuring and separation means.
k) Means of attachment to other structures.
l) Or, similar to those above.
For elongated cylindrical shaped conduits for use in mechanical systems such as;
a) Plumbing waste water, potable water, drainage, non potable water or similar.
b) Heating and air conditioning such as gas piping in the liquid and vapor states.
c) Electrical conduits and wires.
d) Oil piping.
e) Fire protection systems.
f) Hydraulic and pneumatic.
g) or as in related trade disciplines.
These mechanical conduits include ridged piping, semi ridged piping, corrugated piping, tubing, hose or similar to those listed above without discrimination to size, shape, material or use of where the device may be used or placed on, or attached to, or around, or inserted into when sense can be made;
a) Flat or sloped roofs.
b) Decking material.
c) Roof trusses.
d) Beams.
e) Wood planking, 2×4 or 2×6 wood members or similar.
f) Machinery.
g) Enclosure panels or cabinets.
h) Metal channel and strut.
i) Perforated mesh.
j) Ground placement.
k) or objects similar to those mentioned above.
Wherein the support, device or main embodiment may have different attachment attributes from a flat base to a formed base or made to mimic the opposite of the above said objects in which attachment is possible by forming to an object when required.

2. The support, device or main embodiment as set forth in claim 1 wherein thermal expansion and contraction means can be provided within the main embodiment in the form of a circular shape or similar shaped area which may not be entirely in this shape; the said shaped area is dependent upon engineering data and size for a conduit; the area within this invention where compensation is provided for expansion and contraction may be so designed and constructed to where no mechanical components are needed to allow for expansion and contraction of either a conduit or the support, device or main embodiment.

3. The support, device or main embodiment as set forth in claim 1 that may have measuring distances or known constants provided in manufacturing wherein these distances are provided within, or on the support, device or main embodiment which may be marked or labelled or formed as part of or in whole of the support, device or main embodiment where these distances can include;
a) End to end of the support, device or main embodiment.
b) Center of a conduit to end of support, device or main embodiment.
c) Conduit center to center.
d) Top to bottom of the support, device or main embodiment.
e) Bottom of the conduit to bottom of the support, device or main embodiment.
f) Or similar.
Where the support, device or main embodiment may be a constant pre-determined size as such, may provide known distances for conduit separations for parallel or other placement on or within the support, device or main embodiment; providing separation for conduits inhibiting the transfer of temperatures or sound or vibrations or similar from one conduit to another or from conduit to structure in close proximity to the support, device or main embodiment or conduit while adhering to code minimum clearance and hazard assessments.

4. The support, device or main embodiment as set forth in claim 1 that may provide conduit protection from wear, corrosion, dielectric and galvanic actions which includes in the same; protection of the device from wear, corrosion, dielectric and galvanic actions by the use of non metallic materials which may be in contact with a conduit.

5. The support, device or main embodiment as set forth in claim 1 that may have compensation for hydraulic shock, seismic shock, vibration, and structural movement or similar which may include overlaying vibration materials or a pressure holding tab as part of a main embodiment.

6. The support, device or main embodiment as set forth in claim 1 that may have elongated notches or circular depressions or hollows or similar receiving areas formed as part of the support, device or main embodiment to where attachment of identification, marking or labelling or similar is possible by use of marking pins or push tabs or similar devices.

7. The support, device or main embodiment as set forth in claim 1 for attachment to open channel strut, 2×4 or 2×6 or similar wood, steel or similar members, roof trusses, beams or similar to these wherein the sides of the support, device or main embodiment extend passed the structure member where the structure member fits partially or completely inside the support, device or main embodiment; where the support, device or main embodiment completely encompass the structure the bottom of the support, device or main embodiment may have an interlocking portion of the support, device or main embodiment formed as part of the support, device or main embodiment.

8. The support, device or main embodiment as set forth in claim 1 for attachment to an open channel strut having opposing longitudinal ridges formed within the sides where the support, device or main embodiment of the said device has a flat base and attachment is not made inside the open channel strut but on top of the open channel strut; the opening of the open channel strut is directly under the base of the support, device or main embodiment of the said device where attachment is made to a retainer placed within the open channel strut under the opposing longitudinal ridges of the open channel strut where a fastener is used which passes through the support, device or main embodiment of the said device into the retainer to where the retainer pulls together the said device to the open channel strut holding the base of the support, device or main embodiment of the said device to the top of the open channel strut and the top of a retainer to the underside ridges of the top of the open channel strut.

9. The support, device or main embodiment as set forth in claim 1 for attachment to or within open channel strut having opposing longitudinal ridges formed within the sides wherein the main embodiment of the device has the same corresponding grooves to fit the ridges of the open channel strut which is fit by friction into the open channel strut; the support, device or main embodiment of the device has an elongated open bottom with outside legs wherein the legs deflect inward when inserted into an open channel strut and then return to their original resting state which is held by friction or to where the support, device or main embodiment of the said device can be secured by means of a wedge shaped device placed inside the elongated open bottom of the said device between the outside legs; the wedge shaped device can be attached by attachment hardware including bolts or a pull tab; when the pull tab is pulled upward into the support, device or main embodiment this action causes or applies an outward force to the legs of the device's support, device or main embodiment pressing the said legs to the inside of the open channel strut securing the support, device or main embodiment as set forth in claim 1 into an open channel strut.

10. The support, device or main embodiment as set forth in claim 1 that may provide or be fitted with break away points for shortening the device in physical length and or providing notification for measurements to where cutting is possible.

11. The support, device or main embodiment as set forth in claim 1 that provides one or more points for a conduit to be attached to on the same embodiment or device wherein a lower area or areas are formed within or are part of one embodiment or device or support to allow for;
a) Inspection of components and inspection of the conduit joints held within.
b) Testing of components and testing of the conduit joints held within.
c) Visual identification of components and the joints held within and surrounding area illuminating by use of lighting.
d) Fixed attachment anchor points which can include expansion and contraction compensation.
e) Lighting and lighting accessories.
f) Drainage of water, condensate or similar.
g) Or, an open area for other purposes.
Where, the upper areas or ridges of attachment for a conduit include;
a) Two opposing ridges including parallel ridges connected by a lower area. “Insert Double Block” “Double Block”
b) Two perpendicular ridges connected by one or up to two lower areas. “Insert 90 Block” “90 Block”
c) Three ridges, two opposing or parallel and one perpendicular connected by one or up to three lower areas. “Insert T Block” “T Block”
d) Any combinations of geometrically shaped embodiments or supports in which a conduit is supported at more than one location within or on a said device, embodiment or support to where a component of a conduit is positioned in a manner that represents or provides support in more than one location around a component.
Where, each upper ridge can include the conduit insert opening of claim 1 or be formed continuous as set forth in claim 1 while providing the same attachment areas and lower areas.

12. The support, device or main embodiment as set forth in claim 1 that can provide for washers and nuts or similar mechanical hardware to be restrained within the main embodiment which can include recessed areas on the top, bottom, either side or within hollow areas for the purpose of attachment for threaded rods, bolts or similar mechanisms; this includes the methods of forming holes, depressions, hollows, or voids which can be cast, stamped, drilled, formed as part of, molded, machined or similar at the time of manufacturing; the recessed areas can be round, square, hexagon shaped or of a shape required to retain such nuts or washers or similar hardware. Areas that are deemed for attachment and are not made void of materials may be given identification in a form that would be understood by those skilled in the art of mechanical devices; if other than those described above the main embodiment can allow for attachment manipulation on site by drilling or similar including attaching alternate materials as needed.

13. The support, device or main embodiment as set forth in claim 1 which can have recessed push holes formed within the support, device or main embodiment.

14. The support, device or main embodiment as set forth in claim 1 which can have elongated slots or attachment areas built within the support, device or main embodiment for the purpose of controlling expansion and contraction forces imposed on the support, device or main embodiment which also function as attachment points for the support, device or main embodiment to be physically attached to a structure.

15. A push pin or cylindrical tapered pin formed as part of a cover as set forth in claim 18 which can be inserted into a similar shaped push holes of a support, device or main embodiment as set forth in claim 1; this cylindrical tapered pin may have a elongated void or voids as part of the cylindrical tapered pin extending from the bottom tip to the underside of the cover to allow for inward deflection of the cylindrical tapered pin material when pressed into the push holes of the support, device or main embodiment where the cylindrical tapered pin can become dislodged if a greater force than the engineered design holding force allows.

16. Marking pins or push tabs or similar devices used as marking or identification labels for attachment to the support, device or main embodiment and/or the receiving areas as set forth in claim 6.

17. A device or elongated support attachments can be provided for support and protection for the underside of conduits where these now said elongated supports may be attached to the main embodiments of the device as set forth in claim 1.

18. The support, device or main embodiment as set forth in claim 1 which can include a cover plate and/or protection platform that will provide physical protection for conduits supported within the device with options for the protection of elongated lengths of conduits supported by the main embodiment as set forth in claim 1 but outside of the physical support, device or main embodiment of claim 1 where the cover plate may have holding tabs formed in whole or in part of the cover plate, a light or a cylindrical tapered pin (push pin) for attachment to the support, device or main embodiment of claim 1.

19. A method of conduit release as set forth in claim 15.

20. A method of providing conduit isolation or separation from conduit to conduit or conduit to building or other structures as set forth in claim 3.

21. A method of providing engineering within the device, support or main embodiment as set forth in claim 2; a means in which thermal expansion and contraction can be provided within the device, support or main embodiment as set forth in claim 1 which includes sizing an area for supporting a conduit in where the conduit support area is larger than the conduit which may be or not be in the shape of the conduit.

22. A method of providing multiple points of conduit attachment areas to one support, device or main embodiment which can include close proximity conduit attachment points where protection is provided for a component and the method of attachment of a conduit to the component installed within the conduit as set forth in claim 11 while providing an area for where desired;
a) Inspection of components and inspection of the conduit joints held within.
b) Testing of components and testing of the conduit joints held within.
c) Visual identification of components and the joints held within and surrounding area illuminating by use of lighting.
d) Fixed attachment anchor points which can include expansion and contraction compensation.
e) Lighting and lighting accessories.
f) Drainage of water, condensate or similar.
g) Or, an open area for other similar purposes.
